(19) United States
(12) Patent Application Publication
(10) Pub. No.: US 2025/0056165 A1
(43) Pub. Date: Feb. 13, 2025

(54) TRANSDUCER AND MANUFACTURING METHOD THEREOF

(71) Applicant: ROHM CO., LTD., KYOTO-SHI (JP)

(72) Inventor: TATSUYA SUZUKI, KYOTO-SHI (JP)

(21) Appl. No.: 18/796,027

(22) Filed: Aug. 6, 2024

(30) Foreign Application Priority Data
Aug. 10, 2023 (JP) 2023-131330

(51) Int. Cl. H04R 17/00; H04R 31/00

(52) U.S. Cl. CPC H04R 17/00; H04R 31/00

(57) ABSTRACT

The present disclosure provides a transducer. The transducer includes: a support substrate, having a first cavity; an oscillating device; and a lid, having a second cavity and bonded to the oscillating device by an adhesive. The oscillating device includes a first frame and an oscillating unit. A portion of the oscillating unit is connected to the first frame. When viewed from a connection direction of the oscillating device and the lid, the portion of the oscillating unit other than a connecting portion between the oscillating unit and the first frame is separated from the first frame by a slit penetrating the oscillating device along the connection direction. The lid has a second frame surrounding the second cavity and including a second bonding surface bonded to the first bonding surface by the adhesive. The first cavity and the second cavity are connected by the slit.

### TECHNICAL FIELD

The present disclosure relates to a transducer and a manufacturing method of a transducer.

### BACKGROUND

Patent publication 1 discloses a transducer. The transducer includes a membrane support section having a mode cavity, a cantilever oscillating membrane, and a piezoelectric element formed on the oscillating membrane. In the transducer in patent publication 1, the membrane support section surrounds the oscillating membrane, and is connected to one side of the oscillating membrane. A gap is formed between the remaining three sides of the oscillating membrane and the support section.

### PRIOR ART DOCUMENT

### Patent Publication

[Patent document 1] Japan Patent Publication No. 2021-52305

### BRIEF DESCRIPTION OF THE DRAWINGS

FIG. 1 is a plan view of a sound wave generating device according to a first embodiment.

FIG. 2 is a bottom view of a sound wave generating device according to the first embodiment.

FIG. 3A is a cross-sectional view of the sound wave generating device in FIG. 1 along the line IIIa-IIIa.

FIG. 3B is a cross-sectional view of the sound wave generating device in FIG. 1 along the line IIIb-IIIb.

FIG. 4 is a cross-sectional view of the sound wave generating device in FIG. 1 along the line VI-VI.

FIG. 5 is an exploded cross-sectional view of a sound wave generating device according to the first embodiment.

FIG. 6 is a plan view of a substrate assembly in the sound wave generating device in FIG. 1.

FIG. 7 is a cross-sectional view along the line VII-VII in FIG. 6.

FIG. 8 is an enlarged diagram of the region A in FIG. 3A.

FIG. 9 is a diagram of a lid included in the sound wave generating device shown in FIG. 1 viewed from an oscillating device.

FIG. 10 is a cross-sectional view of a step of a manufacturing process of a semi-finished product (a laminate) of a substrate assembly in an example of a manufacturing method of a sound wave generating device according to the first embodiment.

FIG. 11 is a cross-sectional view of a step implemented after the step in FIG. 10.

FIG. 12 is a cross-sectional view of a step implemented after the step in FIG. 11.

FIG. 13 is a cross-sectional view of a step implemented after the step in FIG. 12.

FIG. 14A is a plan view of a step implemented after the step in FIG. 13.

FIG. 14B is a cross-sectional view along the line XIVb-XIVb in FIG. 14A.

FIG. 15A is a plan view of a step implemented after the steps in FIG. 14A and FIG. 14B.

FIG. 15B is a cross-sectional view along the line XVb-XVb in FIG. 15A.

FIG. 16 is a cross-sectional view of a step of a manufacturing process of a lid in an example of a manufacturing method of a sound wave generating device according to the first embodiment.

FIG. 17A is a plan view of a step implemented after the step in FIG. 16.

FIG. 17B is a cross-sectional view along the line XVIIb-XVIIb in FIG. 17A.

FIG. 18A is a plan view of a step implemented after the steps in FIG. 17A and FIG. 17B.

FIG. 18B is a cross-sectional view along the line XVIIIb-XVIIIb in FIG. 18A.

FIG. 19 is a cross-sectional view of a step implemented after the steps in FIG. 18A and FIG. 18B.

FIG. 20 is a cross-sectional view of a step implemented after the step in FIG. 19.

FIG. 21 is a cross-sectional view of a step implemented after the step in FIG. 20.

FIG. 22 is a cross-sectional view of a lid obtained by implementing a step after the step in FIG. 21.

FIG. 23 is a diagram of a bonding step of a semi-finished product (a laminate) of a substrate assembly and a lid in an example of a manufacturing method of a sound wave generating device according to the first embodiment.

FIG. 24 is a diagram for illustrating a reference example of a method of forming a hole in a silicon layer.

FIG. 25 is a diagram of a method of forming a hole on a silicon substrate when a silicon oxide film is present on a silicon layer.

FIG. 26 is a plan view of a sound wave generating device according to a second embodiment.

FIG. 27 is a cross-sectional view of the sound wave generating device in FIG. 26 along the line XXVI-XXVI.

FIG. 28 is a diagram of a lid included in the sound wave generating device shown in FIG. 26 viewed from an oscillating device.

FIG. 29 is a cross-sectional view of a step of a manufacturing process of a lid included in a sound wave generating device according to the second embodiment.

FIG. 30 is a cross-sectional view of a step implemented after the step in FIG. 29.

FIG. 31 is a cross-sectional view of a step implemented after the step in FIG. 30.

FIG. 32 is a plan view of a sound wave generating device according to a third embodiment.

FIG. 33 is a cross-sectional view of the sound wave generating device in FIG. 32 along the line XXXIII-XXXIII.

FIG. 34 is a plan view of a sound wave generating device according to a fourth embodiment.

FIG. 35 is a cross-sectional view of the sound wave generating device in FIG. 34 along the line XXXV-XXXV.

FIG. 36 is a plan view of a sound wave generating device according to a first variation example.

FIG. 37 is a cross-sectional view of the sound wave generating device 1 in FIG. 36 along the line XXXVII-XXXVII.

FIG. 38 is a cross-sectional view of the sound wave generating device 1 in FIG. 36 along the line XXXIII-XXXIII.

FIG. 39 is a diagram illustrating a second variation example.

### DETAILED DESCRIPTION OF THE EMBODIMENTS

### Detailed Description

Details of the embodiments are given with the accompanying drawings below. The same elements or elements having the same functions are denoted by the same numerals or symbols in the description, and repeated details are omitted.

### First Embodiment

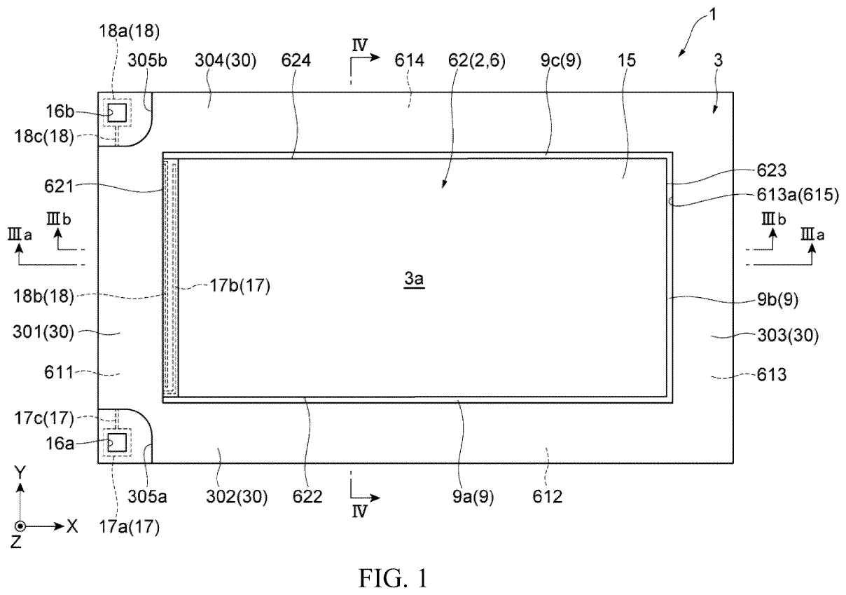

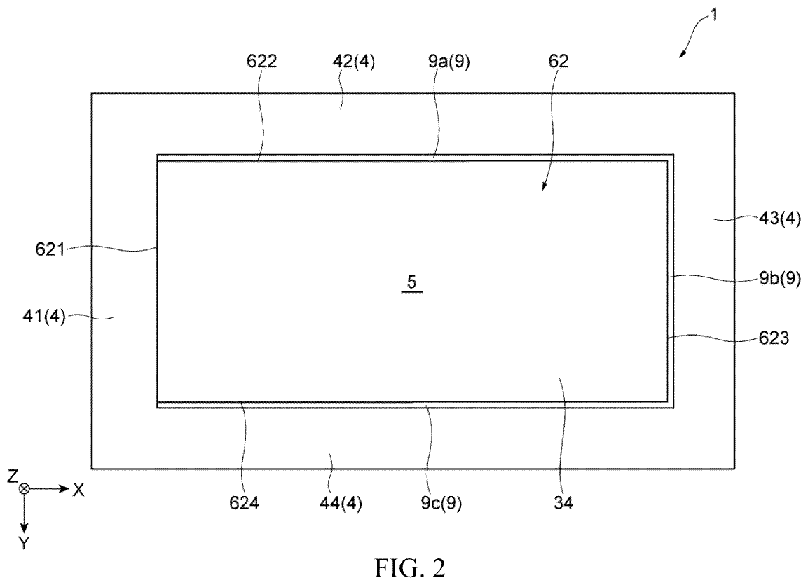

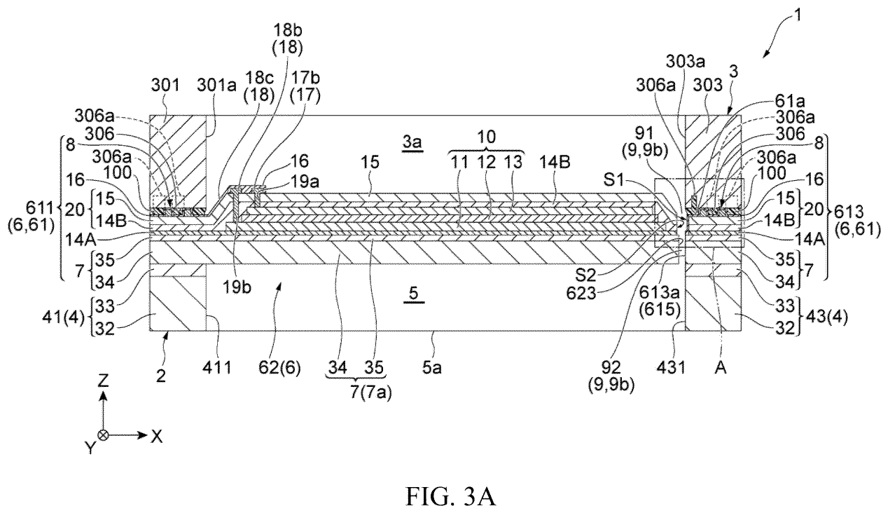

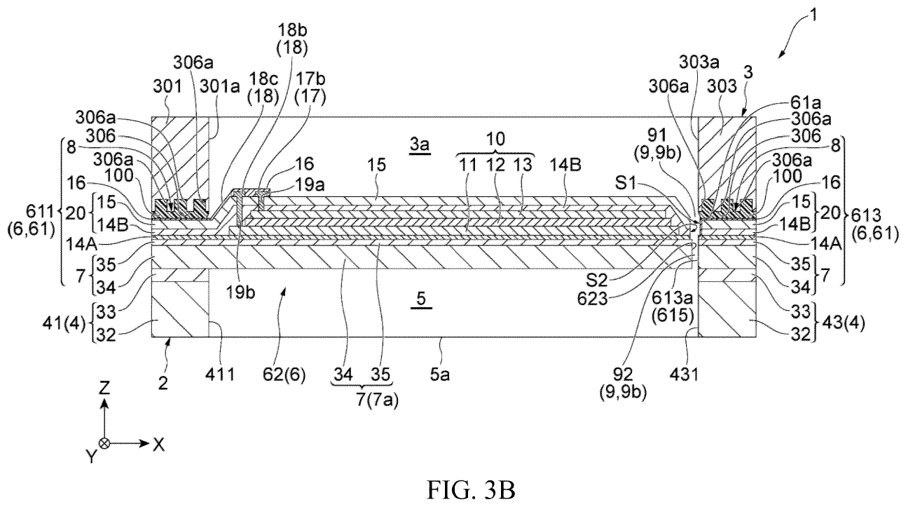

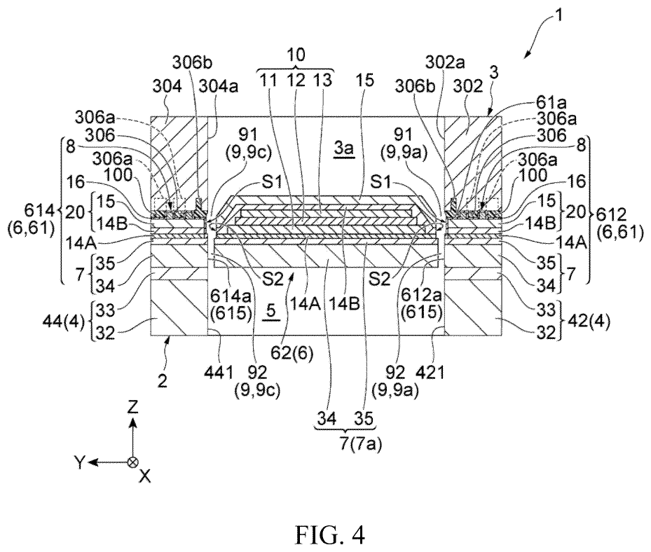

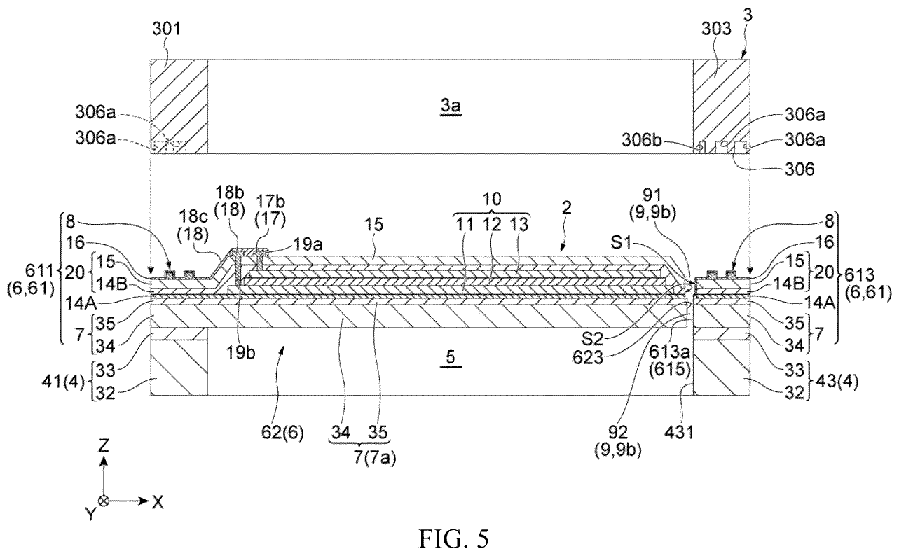

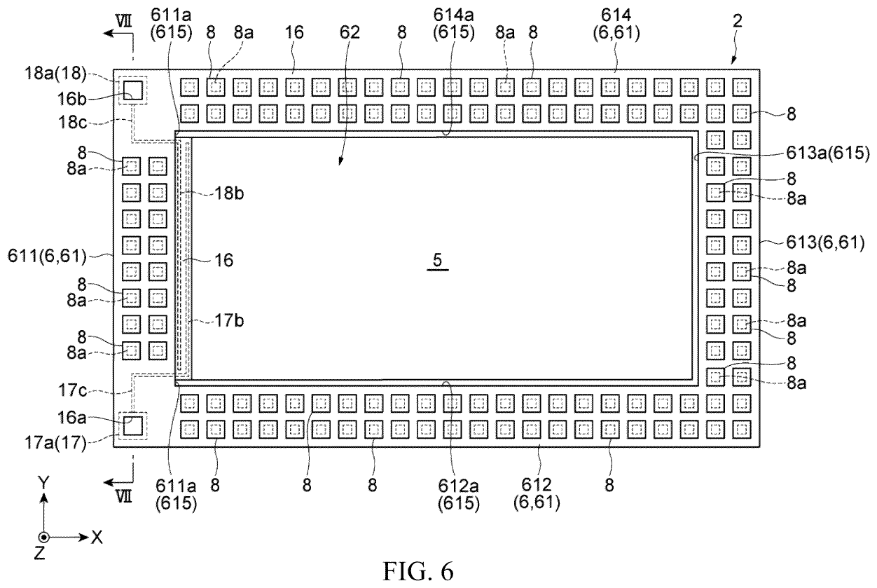

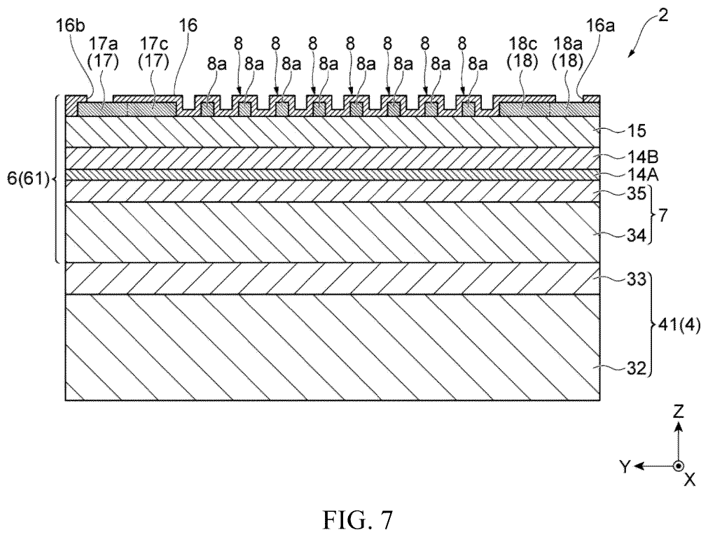

FIG. 1 shows a plan view of a sound wave generating device (a transducer) according to a first embodiment. FIG. 2 shows a bottom view of a sound wave generating device according to the first embodiment. FIG. 3A shows a cross-sectional view of the sound wave generating device in FIG. 1 along the line IIIa-IIIa. FIG. 3B shows a cross-sectional view of the sound wave generating device in FIG. 1 along the line IIIb-IIIb. FIG. 4 shows a cross-sectional view of the sound wave generating device in FIG. 1 along the line VI-VI. FIG. 5 shows an exploded cross-sectional view of a sound wave generating device according to the first embodiment. FIG. 5 shows a state of a lid and a substrate assembly separated from each other in the sound wave generating device in FIG. 3A. FIG. 6 shows a plan view of a substrate assembly in the sound wave generating device in FIG. 1. FIG. 7 shows a cross-sectional view along the line VII-VII in FIG. 6.

The sound wave generating device 1 is a device that oscillates air by means of oscillation of a piezoelectric film and thus generates sound waves. The sound wave generating device 1 employing oscillation of a piezoelectric film can also be referred to as a piezoelectric film device. The sound wave generating device 1 can be, for example, a speaker, or can be an ultrasonic wave generating device generating ultrasonic waves. At this point, both of the speaker and the ultrasonic wave generating device oscillate air and can operate by substantially the same structure, but use different frequency domains, that is, an audible range and an ultrasonic range. The sound wave generating device 1 is, for example, implemented by a microelectromechanical systems (MEMS) employing piezoelectric properties. The sound wave generating device 1 in the form of a speaker is described below.

As shown in FIG. 1, FIG. 2, FIG. 3A, FIG. 3B, FIG. 4 and FIG. 5, the sound wave generating device 1 includes a substrate assembly 2 and a lid 3. The lid 3 is bonded to the substrate assembly 2 by an adhesive 100. The substrate assembly 2 includes a support substrate 4, and an oscillating device 6 disposed on the support substrate 4.

The support substrate 4 has a quadrilateral shape (a substantially rectangular shape) in a plan view. In the description below, a lengthwise direction of the support substrate 4 having a substantially rectangular shape in the plan view is set as an X direction, the widthwise direction is set as a Y direction, and a direction intersecting the X direction and the Y direction (that is, a thickness direction of the support substrate 4) is set as a Z direction for illustration. The Z direction is also a connection direction of the oscillating device 6 included in the substrate assembly 2 and the lid 3. In the Z direction, a direction of a location of the oscillating device 6 with the support substrate 4 as a reference is set as “up/top”, and a direction of a location of the support substrate 4 with a piezoelectric element 10 as a reference is set as “down/bottom” for illustration.

The support substrate 4 includes a silicon (Si) substrate 32, and an oxide film 33 formed on a surface of the silicon substrate 32. A thickness of the support substrate 4 is, for example, approximately 380 μm.

The support substrate 4 has a mode cavity (a first cavity) 5 formed by a through hole penetrating in the Z direction. The mode cavity 5 is a cuboid shape in the plan view, with a quadrilateral opening 5a on a side of a lower surface (a bottom surface) of the mode cavity 5 as a bottom surface.

The support substrate 4 has a frame shape in the plan view. The support substrate 4 includes a first portion 41, a second portion 42, a third portion 43 and a fourth portion 44. The first portion 41 and the third portion 43 extend along the Y direction to be separated from each other by the mode cavity 5 in the X direction. The second portion 42 and the fourth portion 44 extend along the X direction to be separated from each other by the mode cavity 5 in the Y direction. That is, the first portion 41, the second portion 42, the third portion 43 and the fourth portion 44 surround the mode cavity 5.

An inner surface 411 of the first portion 41, an inner surface 421 of the second portion 42, an inner surface 431 of the third portion 43 and an inner surface 441 of the fourth portion 44 are also side surfaces of the mode cavity 5. Unless otherwise specified, the inner surface 411, the inner surface 421, the inner surface 431 and the inner surface 441 are flat surfaces.

As shown in FIG. 3A, FIG. 3B, FIG. 4, FIG. 5 and FIG. 6, the oscillating device 6 includes a first frame 61 surrounding the mode cavity 5 when viewed from the lid 3, and a cantilever (an oscillating unit) 62 facing to the mode cavity 5 in the plan view. A portion of the cantilever 62 is connected to the first frame 61. The portion of the cantilever 62 other than the connecting portion to the first frame 61 is separated from the first frame 61 by a slit 9 penetrating the oscillating device 6 along the Z direction.

The first frame 61 has a shape same as that of the support substrate 4 in the plan view. That is, the shape of the first frame 61 in the plan view is substantially rectangular in the plan view. The first frame 61 includes a first portion 611, a second portion 612, a third portion 613 and a fourth portion 614.

The first portion 611 is supported by the first portion 41 of the support substrate 4. The first portion 611 is along the Y direction on the first portion 41.

The second portion 612 is supported by the second portion 42 of the support substrate 4. The second portion 612 is along the X direction on the second portion 42.

The third portion 613 is supported by the third portion 43 of the support substrate 4. The third portion 613 is along the Y direction on the third portion 43.

The fourth portion 614 is supported by the fourth portion 44 of the support substrate 4. The fourth portion 614 is along the X direction on the fourth portion 44.

The first frame 61 is a portion in the oscillating device 6 bonded to the lid 3. A surface of the first frame 61 is a bonding surface (a first bonding surface) 61a to the lid 3. As shown in FIG. 6, on the bonding surface 61a, multiple convex portions 8 are discretely arranged to surround the mode cavity 5 in the plan view.

In the form shown in FIG. 6, when viewed along the Z direction, the multiple convex portions 8 are arranged in two layers around the mode cavity 5 surround the mode cavity 5. More specifically, two columns of convex portions are arranged at an interval along the X direction at the first portion 41 and the third portion 43, and the two columns of convex portions are configured to include the multiple convex portions 8 discretely arranged along the Y direction. Two columns of convex portions are arranged at an interval along the Y direction at the second portion 42 and the fourth portion 44, and the two columns of convex portions are configured to include the multiple convex portions 8 discretely arranged along the X direction.

In the present disclosure, the bonding surface 61a refers to a surface of the first frame 61 when the convex portions 8 are not yet formed. That is, a plane including a bottom surface of the convex portion 8 is the bonding surface 61a.

The multiple convex portions 8 can function as separators between the oscillating device 6 and the lid 3. As shown in FIG. 3A, FIG. 3B and FIG. 4, the oscillating device 6 and the lid 3 are bonded by the adhesive 100 in a gap formed by the multiple convex portions 8.

The number and configuration of the convex portions 8 are not limited to the examples above. The multiple convex portions 8, instead of being in two layers surrounding the mode cavity 5, can also be arranged in one layer to surround the mode cavity 5, or can be arranged in three or more layers to surround the mode cavity 5. The convex protrusions 8 respectively disposed at the first portion 611, the second portion 612, the third portion 613 and the fourth portion 614 can also extend along respective extension directions of the first portion 611, the second portion 612, the third portion 613 and the fourth portion 614.

The cantilever 62 has the piezoelectric element 10. The cantilever 62 is configured to oscillate in the Z direction via the piezoelectric element 10. A portion of the cantilever 62 is connected to the first frame 61. When viewed along the Z direction, a portion of the cantilever 62 other than the connecting portion to the first frame 61 is separated from the first frame 61 by the slit 9 penetrating the oscillating device 6 along the Z direction. In the description below, unless otherwise specified, the cantilever 62 is in a form of being connected to the first portion 611 of the first frame 61.

The cantilever 62 has a rectangular shape substantially similar to that of the mode cavity 5 in the plan view. The cantilever 62 has a first edge 621, a second edge 622, a third edge 623 and a fourth edge 624. The first edge 621, the second edge 622, the third edge 623 and the fourth edge 624 form an outer periphery of the cantilever 62 in the plan view.

The first edge 621 is along the Y direction. The first edge 621 is a connecting portion of the first portion 611 of the first frame 61.

The second edge 622 is along the X direction. The second edge 622 faces to the second portion 612 of the first frame 61. The second edge 622 is separated from the second portion 612 by the slit 9. In the slit 9, a portion that separates the second edge 622 from the second portion 612 is referred to as a first portion 9a.

The third edge 623 is along the Y direction. The third edge 623 faces to the third portion 613 of the first frame 61. In the slit 9, a portion that separates the third edge 623 from the third portion 613 is referred to as a second portion 9b.

The fourth edge 624 is along the X direction. The fourth edge 624 faces to the fourth portion 614 of the first frame 61. In the slit 9, a portion that separates the third edge 623 from the third portion 613 is referred to as a third portion 9c.

A layer configuration of the oscillating device 6 is described with reference to FIG. 3A, FIG. 3B, FIG. 4 and FIG. 5.

The oscillating device 6 has an oscillating membrane formation layer 7. The oscillating membrane formation layer 7 is formed on the support substrate 4. The oscillating membrane formation layer 7 is a lamination layer in which a silicon layer (an active layer containing silicon) 34 and a silicon oxide film (a silicon oxide layer) 35 are sequentially laminated from the side of the support substrate 4. A film thickness of the silicon layer 34 is, for example, about 20 μm. A film thickness of the silicon oxide film 35 is, for example, about 1.5 μm.

In the first embodiment, a first hydrogen barrier film 14A is formed on the oscillating membrane formation layer 7. The first hydrogen barrier film 14A includes, for example, an aluminum oxide (Al₂O₃) film. A thickness of the first hydrogen barrier film 14A is, for example, between about 20 nm and about 100 nm. A portion of the oscillating membrane formation layer 7 included in the cantilever 62 is referred to as an oscillating membrane 7a.

The piezoelectric element 10 is disposed on a portion of the first hydrogen barrier film 14A within the cantilever 62. The piezoelectric element 10 includes a lower electrode 11 formed on the first hydrogen barrier film 14A, a piezoelectric film 12 formed on the lower electrode 11, and an upper electrode 13 formed on the piezoelectric film 12.

The lower electrode 11 and the upper electrode 13 are formed by conductive metal films containing such as platinum (Pt), molybdenum (Mo), iridium (Ir), titanium (Ti). A film thickness of the lower electrode 11 is, for example, 200 nm, and a film thickness of the upper electrode 13 is, for example, 80 nm.

The piezoelectric film 12 includes, for example, lead zirconate titanate (PZT). The piezoelectric film 12 can also include niobium-doped lead zirconate titanate (PNZT) film, a lanthanum-doped lead zirconate titanate (PLZT) film, a barium strontium titanate (BST) film, a strontium bismuth tantalate (SBT) film, a strontium barium niobate (SBN) film, a lithium niobium phosphate (LiNbO₃) film, a barium titanate (TiBaO₃) film, a lanthanum strontium copper oxide (LSCO) film, a potassium dihydrogen phosphate (KDP) film, a potassium tantalum niobate (KTN) film, a magnesium lead titanate niobate (PMN-PT) based ceramic film, a zinc niobate lead titanate (PZN-PT) based ceramic film, aluminum nitride (AlN), zinc oxide (ZnO), lead titanate (PbTiO₃). A film thickness of the piezoelectric film 12 is, for example, about 2 μm.

A second hydrogen barrier film 14B is formed on the first hydrogen barrier film 14A. On a portion of the first hydrogen barrier film 14A where the piezoelectric element 10 is formed, the piezoelectric element 10 is covered by the second hydrogen barrier film 14B. The second hydrogen barrier film 14B includes, for example, an aluminum oxide film. A thickness of the second hydrogen barrier film 14B is, for example, between about 20 nm and about 100 nm. The second hydrogen barrier film 14B is provided to prevent characteristics degradation caused by hydrogen reduction of the piezoelectric film 12.

An interlayer insulative film 15 is laminated on the second hydrogen barrier film 14B. The interlayer insulative film 15 is formed by, for example, a tetraethyl orthosilicate (TEOS) film. The interlayer insulative film 15 can include such as silicon nitride (SiN). A thickness of the interlayer insulative film 15 is for example, between about 0.2 μm and about 1.5 μm.

In the description below, the second hydrogen barrier film 14B and the interlayer insulative film 15 are sometimes collectively referred to as an insulative film 20.

As shown in FIG. 6, an upper wiring 17 and a lower wiring 18 are formed on the interlayer insulative film 15. The lower wiring 18 and the upper wiring 17 are formed of, for example, a metal material containing aluminum (Al). Thicknesses of the lower wiring 18 and the upper wiring 17 are, for example, 1 μm.

The upper wiring 17 includes an upper pad 17a, a first wiring portion 17b and a second wiring portion 17c. The upper pad 17a is disposed near a corner formed by the first portion 611 and the second portion 612 of the first frame 61 in the plan view. The upper pad 17a is formed to be wider than the first wiring portion 17b and the second wiring portion 17c. The first wiring portion 17b is disposed on an end of the interlayer insulative film 15 located on the side of the first edge 621 of the cantilever 62. The first wiring portion 17b extends along the Y direction. The second wiring portion 17c is a portion of the upper wiring 17 connected to the upper pad 17a and the first wiring portion 17b.

A contact hole 19a (referring to FIG. 3A, FIG. 3B and FIG. 5) contiguously penetrating the second hydrogen barrier film 14B and the interlayer insulative film 15 is formed between the first wiring portion 17b and the upper electrode 13. A portion of the first wiring portion 17b enters the contact hole 19a, and is connected to the upper electrode 13 in the contact hole 19a. Multiple contact holes 19a can also be formed discretely along the Y direction.

The lower wiring 18 includes a lower pad 18a, a first wiring portion 18b and a second wiring portion 18c. The lower pad 18a is disposed near a corner formed by the first portion 611 and the fourth portion 614 of the first frame 61 in the plan view. The lower pad 18a is formed to be wider than the first wiring portion 18b and the second wiring portion 18c. The first wiring portion 18b is disposed on an end (a rear end) of the interlayer insulative film 15 located on the side of the connecting portion between the cantilever 62 and the first frame 61. The first wiring portion 18b extends along the Y direction. The first wiring portion 18b is separated from the first wiring portion 17b in the X direction. The second wiring portion 18c is a portion of the lower wiring 18 connected to the lower pad 18a and the first wiring portion 18b.

A contact hole 19b (referring to FIG. 3A, FIG. 3B and FIG. 5) contiguously penetrating the second hydrogen barrier film 14B and the interlayer insulative film 15 is formed between the first wiring portion 18b and the lower electrode 11. A portion of the first wiring portion 18b enters the contact hole 19b, and is connected to the lower electrode 11 in the contact hole 19b. Multiple contact holes 19b can also be formed discretely along the Y direction.

On the interlayer insulative film 15, cores 8a included in the convex portions 8 are formed at positions corresponding to the multiple convex portions 8. The core 8a has a shape similar to that of the convex portion 8, and is smaller than the convex portion 8. The core 8a is formed of a metal material containing aluminum. A thickness of the core 8a is, for example, 1 μm.

On the interlayer insulative film 15, a passivation film 16 is formed to cover the upper wiring 17, the lower wiring 18 and the multiple cores 8a. The passivation film 16 is formed by, for example, a tetraethyl orthosilicate (TEOS) film. The passivation film 16 can include such as silicon nitride (SiN). A thickness of the passivation film 16 is for example, between about 0.1 μm and about 1.0 μm.

An upper pad opening 16a exposing a portion of the upper pad 17a and a lower pad opening 16b exposing a portion of the lower pad 18a (referring to FIG. 1) are formed in the passivation film 16.

The multiple convex portions 8 are formed by means of covering the multiple cores 8a by the passivation film 16.

In the oscillating device 6 having the layer configuration, the slit (a gap) 9 is formed to be in communication with the mode cavity 5 by contiguously penetrating from the passivation film 16 to the silicon layer 34.

On an inner surface 615 of the first frame 61 facing to the slit 9, a step (a first step) S1 recessed from the bonding surface 61a in a direction away from the lid 3 (downward in FIG. 3A, FIG. 3B, FIG. 4 and FIG. 5) is formed. More specifically, as shown in FIG. 3A and FIG. 3B, the step S1 is formed on an inner surface 613a of the third portion 613 of the first frame 61. As shown in FIG. 4, the step S1 is formed on an inner surface 612a of the second portion 612 of the first frame 61, and the step S1 is formed on an inner surface 614a of the fourth portion 614 of the first frame 61. The inner surface 612a faces to the first portion 9a of the slit 9, and forms a portion of the inner surface 615. The inner surface 613a faces to the second portion 9b of the slit 9, and forms a portion of the inner surface 615. The inner surface 614a faces to the third portion 9c of the slit 9, and forms a portion of the inner surface 615.

The step S1 is also formed in regions on both sides of the connecting portions to the cantilever 62 in the plan view on an inner surface 611a of the first portion 611 of the first frame 61 (referring to FIG. 6). On the inner surface 611a of the first portion 611, the region in which the step S1 is formed is a region facing to the first portion 9a and the third portion 9c of the slit 9, and forms a portion of the inner surface 615.

A step (a second step) S2 is formed on a portion of the outer periphery of the cantilever 62 facing to the slit 9. More specifically, the step S2 is formed on the second edge 622, the third edge 623 and the fourth edge 624.

The second edge 622 is an edge facing to the first portion 9a of the slit 9.

The third edge 623 is an edge facing to the second portion 9b of the slit 9.

The fourth edge 624 is an edge facing to the third portion 9c of the slit 9.

The step S1 is formed on the inner surface 615 of the first frame 61 facing to the slit 9 and the step S2 is formed on the portion of the outer periphery of the cantilever 62 facing to the slit 9. Thus, in the first embodiment, the slit 9 sequentially has an upper slit portion 91 and a lower slit portion 92 from the passivation film 16 toward the silicon substrate 32. A width of the lower slit portion 92 is less than a width of the upper slit portion 91. A value of the width of the lower slit portion 92 is, for example, between about 1 μm and about 10 μm. The width of the lower slit portion 92 is a portion beneficial for sound characteristics of the sound wave generating device 1.

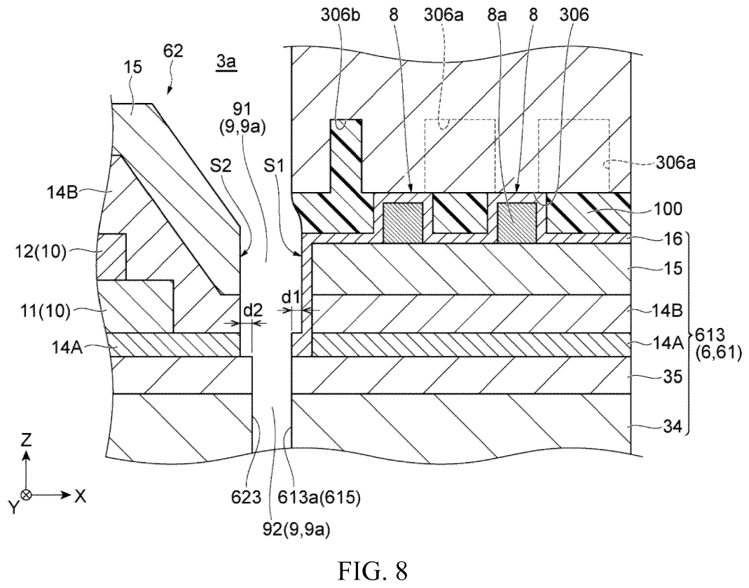

An example of the step S1 and the step S2 is to be described with reference to FIG. 8 below. FIG. 8 shows an enlarged diagram of the region A in FIG. 3A. The steps S1 formed on the inner surfaces 611a, 612a, 613 and 614a have the same configuration. The steps S2 formed on the second edge 622, the third edge 623 and the fourth edge 624 have the same configuration. Thus, FIG. 8 is used to describe the step S1 formed on the inner surface 613a (the inner surface 615) and the step S2 formed on the third edge 623, and details for the steps S1 formed on the inner surfaces 611a, 612a and 614a and the steps S2 formed on the edge 622 and the fourth edge 624 are omitted herein.

As shown in FIG. 8, the step S1 is formed by recessing a predetermined region of the inner surface 613a on a side of the bonding surface 61a in a direction away from the slit 9. Thus, compared to when no step S1 is formed, a corner formed by inner surface 613a and the bonding surface 61a is also recessed in a direction away from the slit 9. An amount of recess d1 is, for example, between about 1 μm and about 5 μm. In the form in FIG. 8, the inner surface 613a is recessed in a region of the inner surface 613a from the bonding surface 61a to the passivation film 16 formed on the silicon oxide film 35. In this first embodiment, the step S1 is partially covered by the passivation film 16.

The step S2 is formed by recessing a predetermined region of the third edge 623 on a side of the interlayer insulative film 15 in a direction away from the slit 9. An amount of recess d2 is, for example, between about 1 μm and about 5 μm. In the form in FIG. 8, the third edge 623 is recessed in a region of the third edge 623 from the surface of the interlayer insulative film 15 to the silicon oxide film 35.

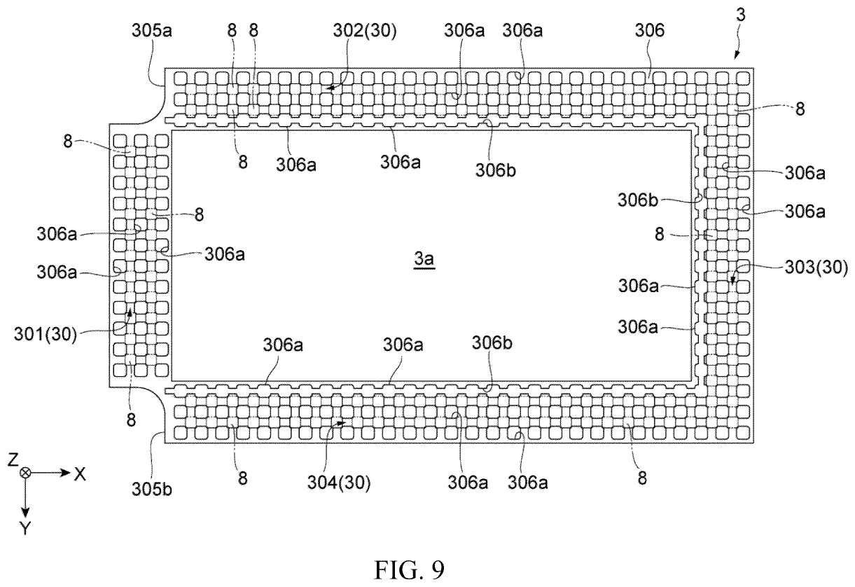

The lid 3 is to be described with reference to FIG. 1, FIG. 3A, FIG. 3B, FIG. 4, FIG. 5, FIG. 8 and FIG. 9 below. FIG. 9 shows a diagram of the lid 3 viewed from the substrate assembly 2. The lid 3 includes a silicon substrate. The lid 3 is disposed on the substrate assembly 2 to cover the oscillating device 6. The lid 3 is bonded to the first frame 61 by the adhesive 100.

The lid 3 has a cavity (a second cavity) 3a formed by a through hole penetrating along the Z direction. The lid 3 has a frame shape when viewed along the Z direction. That is, the lid 3 has a second frame 30. The second frame 30 includes a first portion 301, a second portion 302, a third portion 303 and a fourth portion 304. The first portion 301 and the third portion 303 extend along the Y direction to be separated from each other by the cavity 3a in the X direction. The second portion 302 and the fourth portion 304 extend along the X direction to be separated from each other by the cavity 3a in the Y direction. That is, the first portion 301, the second portion 302, the third portion 303 and the fourth portion 304 surround the cavity 3a.

In a state where the lid 3 and the substrate assembly 2 are bonded, the lid 3 is configured to open portions above the upper pad 17a and the lower pad 18a, so as to readily connect wirings to the upper pad 17a and the lower pad 18a.

More specifically, the first portion 301 is disposed between the upper pad 17a and the lower pad 18a. Ends of the second portion 302 and the fourth portion 304 on a side of the first portion 301 are located closer to the third portion 303 than the upper pad 17a and the lower pad 18a. In other words, in the plan view, the lid 3 has a shape from which two corners are removed, wherein the two corners are formed by extending the first portion 301 toward both sides of the first portion 301 along the X direction, and extending the second portion 302 and the fourth portion 304 toward the first portion 301 along the X direction.

For better description below, with respect to the lid 3, a portion that opens a portion over the upper pad 17a is referred to as an open portion 305a, and a portion that opens a portion over the lower pad 18a is referred to as an open portion 305b.

In the lid 3, multiple concave portions 306a are formed on a bonding surface (a second bonding surface) 306 to the first frame 61. In an example, as shown in FIG. 9, the multiple convex portions 306a are disposed to be adjacent to the convex portions 8 when viewed along the Z direction. The convex portions 8 are represented by double-dotted lines in FIG. 9 so as to indicate a configuration relationship between the concave portions 306a and the convex portions 8. A portion of the concave portions 306a can also overlap with the convex portions 8. In the form in FIG. 9, in the first portion 301 of the lid 3, multiple columns of concave portions along an extension direction (the Y direction in FIG. 9) of the first portion 301 are arranged side by side in a direction (the X direction in FIG. 9) perpendicular to the extension direction of the first portion 301. The columns of concave portions along the extension direction of the first portion 301 are columns formed by the multiple concave portions 306a arranged discretely along the extension direction of the first portion 301. In the form in FIG. 9, the multiple concave portions 306a similar to those in the first portion 301 are also disposed in the second portion 302, the third portion 303 and the fourth portion 304. The concave portion 306a has a square shape in the plan view (a shape when viewed along the Z direction) as an example in FIG. 9, but can also have a rectangular shape, or other shapes such as a polygonal shape and or a circle.

In the form in FIG. 9, in the second portion 302, the third portion 303 and the fourth portion 304, a linear concave portion 306b can be formed by connecting the concave portions 306a forming the column of concave portions closest to the cavity 3a among the multiple columns of concave portions. The form where the concave portion 306b is formed is to be described below. The concave portion 306b can also be formed in the first portion 301.

The concave portion 306a and the concave portion 306b are portions for releasing the adhesive 100 used for bonding the lid 3 and the first frame 61 when the lid 3 and the first frame 61 are bonded, as described below. Since the adhesive 100 enters the concave portion 306a and the concave portion 306b, the concave portion 306a and the concave portion 306b only need to be formed to have volumes capable of preventing the adhesive 100 from overflowing toward the slit 9.

Next, an example of a manufacturing method of the sound wave generating device 1 of the first embodiment is described below. The manufacturing method of the sound wave generating device 1 includes: a step of forming the substrate assembly semi-finished product (a laminate) 2A (a substrate assembly semi-finished product formation step), a step of forming the lid 3 (a lid formation step), a step of bonding the substrate assembly semi-finished product 2A to the lid 3 (a bonding step), and a step of forming the mode cavity 5 in the substrate assembly semi-finished product 2A (a mode cavity formation step). In the mode cavity formation step (a cavity formation step), the substrate assembly semi-finished product 2A is used as a part for obtaining the substrate assembly 2.

### <Substrate Assembly Semi-Finished Product Formation Step>

First of all, the substrate assembly semi-finished product formation step (a laminate formation step) is described.

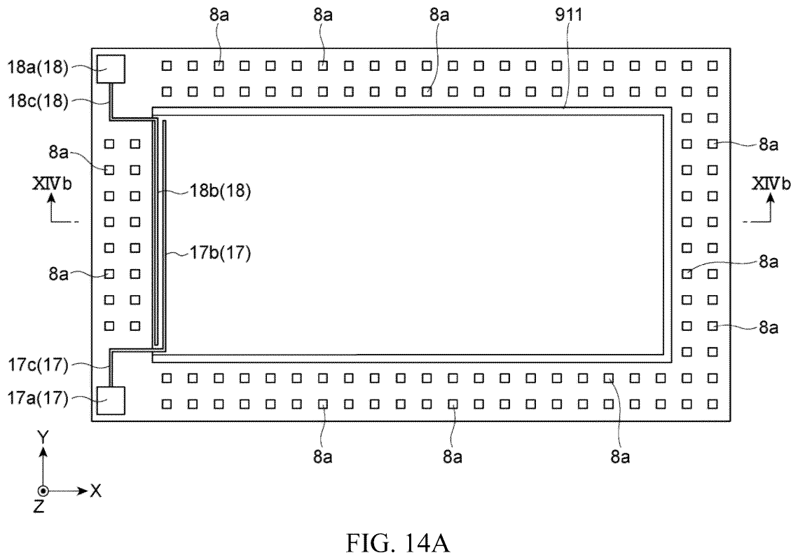

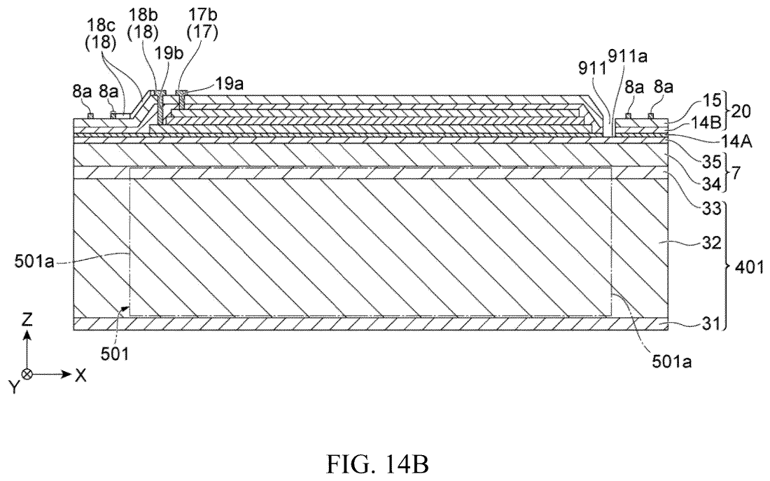

Initially, as shown in FIG. 14, a thermal oxidation treatment is performed on a silicon on insulator (SOI) substrate. The SOI substrate includes the silicon substrate 32 as a support layer, the oxide film 33 as a BOX layer formed on the surface of the silicon substrate 32, and the silicon layer 34 as an active layer formed on the surface of the oxide film 33. With the thermal oxidation treatment, the silicon oxide film 35 is formed on a surface of the silicon layer 34 opposite to the oxide film 33, and a silicon oxide film 31 is formed on a surface of the silicon substrate 32 opposite to the oxide film 33.

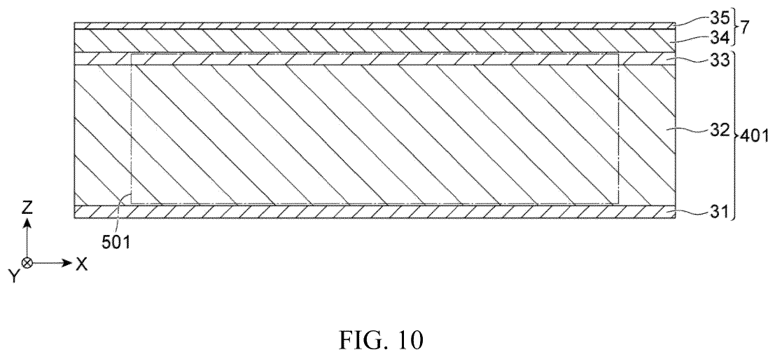

By predetermined processes performed in subsequent steps, the silicon oxide film 35, the silicon substrate 32 and the oxide film 33 shown in FIG. 10 are a portion that is to be the support substrate 4, and the silicon layer 34 and the silicon oxide film 35 are a portion that is to be the oscillating membrane formation layer 7. Thus, when the laminate structure of the silicon oxide film 31, the silicon substrate 32 and the oxide film 33 is referred to as a substrate (a first substrate) 401, the SOI substrate having the laminate structure shown in FIG. 10 by performing a thermal oxidation treatment has a configuration in which the oscillating membrane formation layer 7 is laminated on the substrate 401.

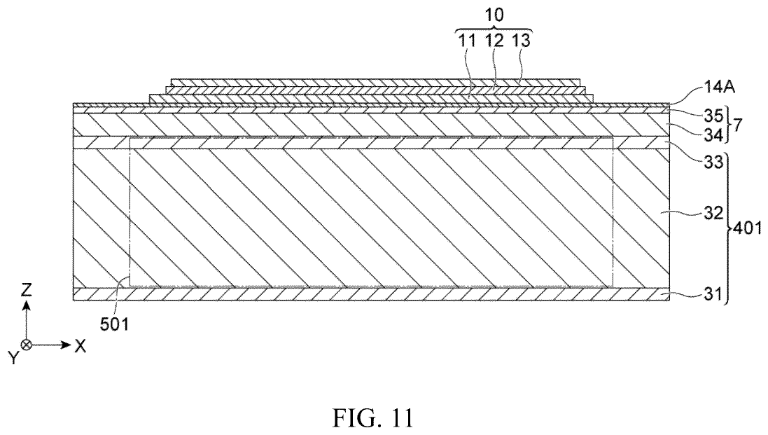

Next, as shown in FIG. 11, the first hydrogen barrier film 14A is formed on the silicon oxide film 35 of the oscillating membrane formation layer 7 (a first hydrogen barrier film formation step). Then, the piezoelectric element 10 is formed on the first hydrogen barrier film 14A (a piezoelectric element formation step). The piezoelectric element 10 is formed above a mode cavity formation predetermined region 501 (a first cavity formation predetermined region) of the substrate 401 that is to be the support substrate 4.

The piezoelectric element 10 is formed by, for example, the following method. A lower electrode film as a material film of the lower electrode 11, a piezoelectric material film as a material film of the piezoelectric film 12 and an upper electrode film as a material film of the upper electrode 13 are sequentially formed on the first hydrogen barrier film 14A. Next, by means of photolithography and etching, the upper electrode film, the piezoelectric material film and the lower electrode film are, for example, sequentially patterned, thereby forming the upper electrode 13, the piezoelectric film 12 and the lower electrode 11. When the upper electrode 13, the piezoelectric film 12 and the lower electrode 11 are obtained from the upper electrode film, the piezoelectric material film and the lower electrode film, the upper electrode film, the piezoelectric material film and the lower electrode film are processed to locate upper electrode 13, the piezoelectric film 12 and the lower electrode 11 above the cavity mode formation predetermined region 501. Thus, the piezoelectric film 12 and the electrodes (the lower electrode 11 and the upper electrode 13) are formed in a region above the cavity mode formation predetermined region 501 in the first hydrogen barrier film 14A, hence forming the piezoelectric element 10.

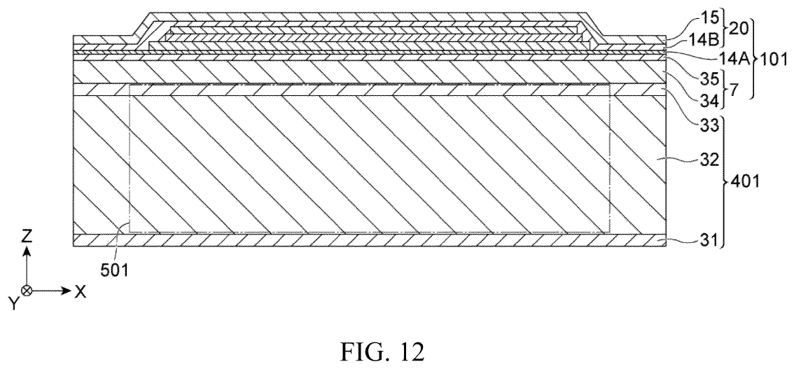

Next, as shown in FIG. 12, the second hydrogen barrier film 14B covering an exposed surface of the silicon oxide film 35 and an exposed surface of the piezoelectric element 10 is formed on the silicon oxide film 35. The second hydrogen barrier film 14B is, for example, an aluminum oxide film. Then, the interlayer insulative film 15 is formed on an entire surface of the second hydrogen barrier film 14B. As described above, the second hydrogen barrier film 14B and the interlayer insulative layer 15 are sometimes collectively referred to as the insulative film 20. Thus, the steps of forming the second hydrogen barrier film 14B and the interlayer insulative film 15 can be referred to as an insulative film formation step.

With the thermal oxidation treatment step, the first hydrogen barrier film formation step, the piezoelectric element formation step and the insulative film formation step above, an intermediate laminate 101 formed by the oscillating membrane formation layer (the silicon layer 34 and the silicon oxide film 35), the first hydrogen barrier film 14A, the piezoelectric member 10 and the insulative film 20 (the second hydrogen barrier film 14B and the interlayer insulative film 15) to be laminated on the substrate 401 of the support substrate 4 is obtained (an intermediate laminate formation step).

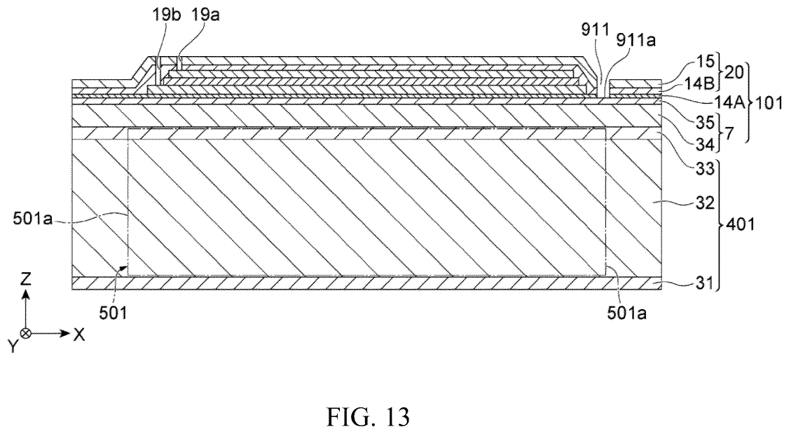

By etching the insulative film 20 (the second hydrogen barrier film 14B and the interlayer insulative film 15) after the intermediate laminate formation step, the contact holes 19a and 19b as shown in FIG. 13 are formed. By etching the insulative film 20 and the first hydrogen barrier film 14A while the contact holes 19a and 19b are formed, a groove 911 to become the upper slit portion 91 is formed (a groove formation step).

The groove 911 is a portion that is to be the upper slit portion 91 as described above. Thus, the groove 911 is formed in a slit formation predetermined region in the intermediate laminate 101. More specifically, when viewed along the Z direction, the groove 911 is formed in a portion along an outer periphery 501a of the mode cavity formation predetermined region 501, other than a portion of the outer periphery 501a of the mode cavity formation predetermined region 501. When viewed along the Z direction, a portion of the outer periphery 501a of the mode cavity formation predetermined region 501 where the groove 911 is not formed is a portion corresponding to the connecting portion between the first frame 51 and the cantilever 62. The groove 911 is formed to have the outer periphery 501a of the mode cavity formation predetermined region 501 on an inside of the groove 911 when viewed along the Z direction. For example, the groove 911 is formed such that the outer peripheral 501a is located at a center of the groove 911 in a widthwise direction when viewed along the Z direction.

Next, as shown in FIG. 14A and FIG. 14B, a wiring film as a material film of the upper wiring 17 and the lower wiring 18 is formed on the interlayer insulative film 15 including the contact holes 19a and 19b. By means of photolithography and etching, the wiring film is patterned to thereby form the upper wiring 17 and the lower wiring 18, and the multiple cores 8a are formed on an outside of the groove 911. The multiple cores 8a are formed at arrangement positions of the multiple convex portions 8. As described above, the core 8a is formed by the wiring film, and so the core 8a can also be referred to as a virtual wiring portion.

Next, on the interlayer insulative film 15, the passivation film 16 is formed to cover the upper wiring 17, the lower wiring 18 and the multiple cores 8a. The interlayer insulative film 15 and the passivation film 16 include, for example, TEOS film.

As described above, the multiple cores 8a are also covered by the passivation film 16, thereby obtaining the multiple convex portions 8. Thus, with the step of forming the cores 8a and the step of forming the passivation film 16, the convex portions 8 are formed (a convex portion formation step).

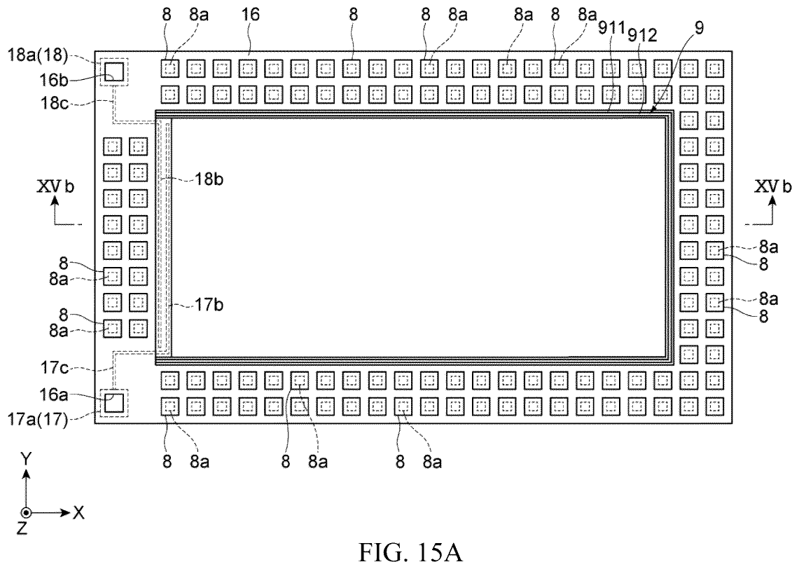

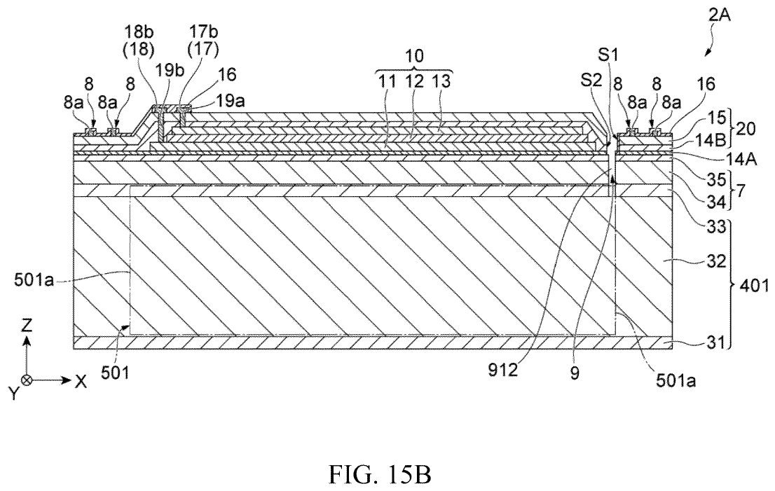

As shown in FIG. 15A and FIG. 15B, by means of photolithography and etching, the upper pad opening 16a exposing a portion of the upper pad 17a and the lower pad opening 16b exposing a portion of the lower pad 18a are formed in the passivation film 16.

Further, by means of photolithography and etching, in a region above the mode cavity formation predetermined region 501 in the passivation film 16, the passivation film 16 other than the region covering the upper wiring 17 and the lower wiring 18 is removed to expose the interlayer insulative film 15. This step can also be omitted.

Further, by means of photolithography and etching, a through hole 912 penetrating the intermediate laminate 101 is formed in a portion of a bottom surface 911a of the groove 911. The through hole 912 is formed to further penetrate the oxide film 33.

More specifically, from the bottom surface 911a, the through hole 912 contiguously penetrating the oscillating membrane formation layer 7 (the silicon oxide film 35 and the silicon layer 34) and the oxide film 33 and reaching the silicon substrate 32 is formed. The through hole 912 is a portion that is to be the lower slit portion 92. Accordingly, the through hole 912 is formed such that a width of the through hole 912 is a width of the lower slit portion 92.

As described above, the through hole 912 is formed to thereby form the slit 9. By forming the slit 9, the first frame 61 and the cantilever 62 are obtained. In other words, the oscillating device 6 having the first frame 61 and the cantilever 62 is obtained. As a result, the substrate assembly semi-finished product 2A as a laminate in which the oscillating device 6 is laminated on the substrate 401 is obtained.

The through hole 912 is formed in a portion of the bottom surface 911a of the groove 911. Thus, a width of the groove 911 is greater than the width of the through hole 912. Accordingly, the through hole 912 is formed as the above to obtain the slit 9 including the upper slit portion 91 and the lower slit portion 92. As described above, the slit 9 is formed by using the groove 911 and the through hole 912, and thus the steps S1 and S2 are also formed in the substrate assembly semi-finished product 2A. Since the through hole 912 is formed after the passivation film 16 is formed, the surface of the step S1 includes the passivation film 16.

### <Lid Formation Step>

The lid formation step is to be described below. Orders for performing the lid formation step and the substrate assembly semi-finished product formation step are not specifically defined.

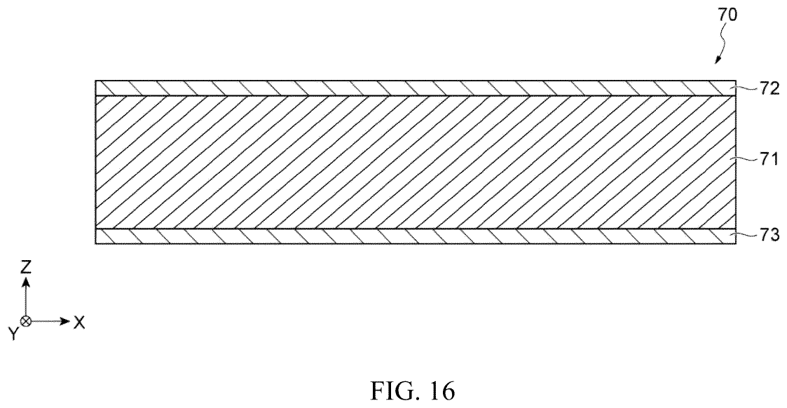

As shown in FIG. 16, a substrate (a second substrate) to become the lid 3 having the cavity 3a is prepared. The substrate 70 has a silicon substrate 71, a first oxide film 72 formed on a surface of the silicon substrate 71, and a second oxide film 73 formed on a back surface (a surface opposite to the surface above) of the silicon substrate 71. The substrate 70 is formed by performing a thermal oxidation treatment on a silicon substrate. More specifically, by performing a thermal oxidation treatment on a silicon substrate, the first oxide film 72 and the second oxide film 73 are formed on the surface and on the back surface. In the silicon substrate having undergone the thermal oxidation treatment, a portion between the first oxide film 72 and the second oxide film 73 is the silicon substrate 71.

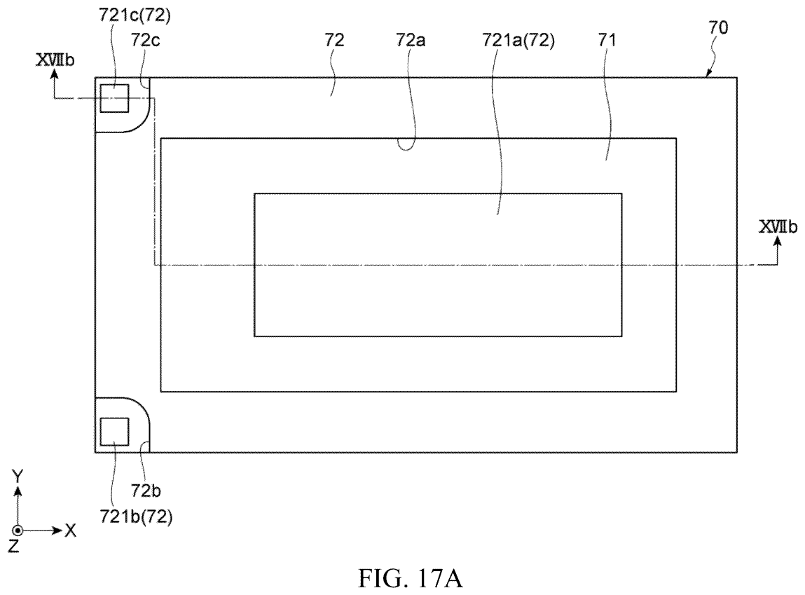

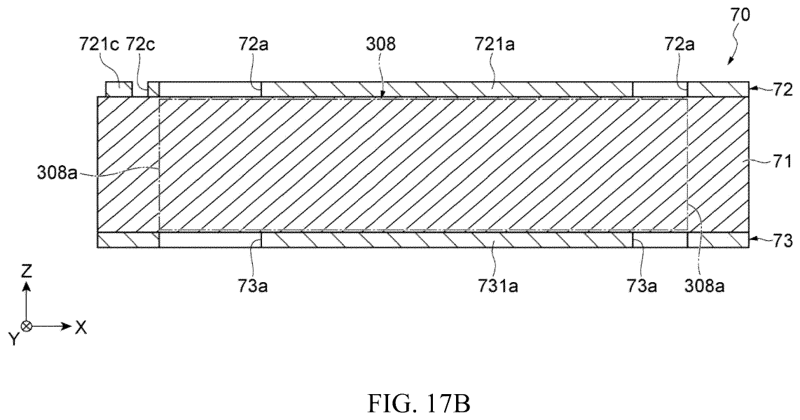

As shown in FIG. 1A and FIG. 17B, by means of lithography and etching, the first oxide film 72 around an island region 721a, an island region 721b and an island 721c is removed to preserve the island region 721a, the island region 721b and the island 721c in the first oxide film 72, thereby forming openings 72a, 72b and 72c.

Similarly, by means of lithography and etching, the first oxide film 72 around an island region 731a, the island region 721b and the island 721c is removed so as to leave the island region 731a, an island region 731b and an island 731c in the second oxide film 73, thereby forming the openings 72a, 72b and 72c.

Outer peripheries of the opening 72a and an opening 73b coincide with an outer periphery of a cavity formation predetermined region 308 in the substrate 70. Outer peripheries of the opening 72b and the opening 73b coincide with an outer periphery of a formation predetermined region of an open region 305a (referring to FIG. 1). Outer peripheries of the opening 72c and an opening 73c coincide with an outer periphery of a formation predetermined region of an open region 305b (referring to FIG. 1).

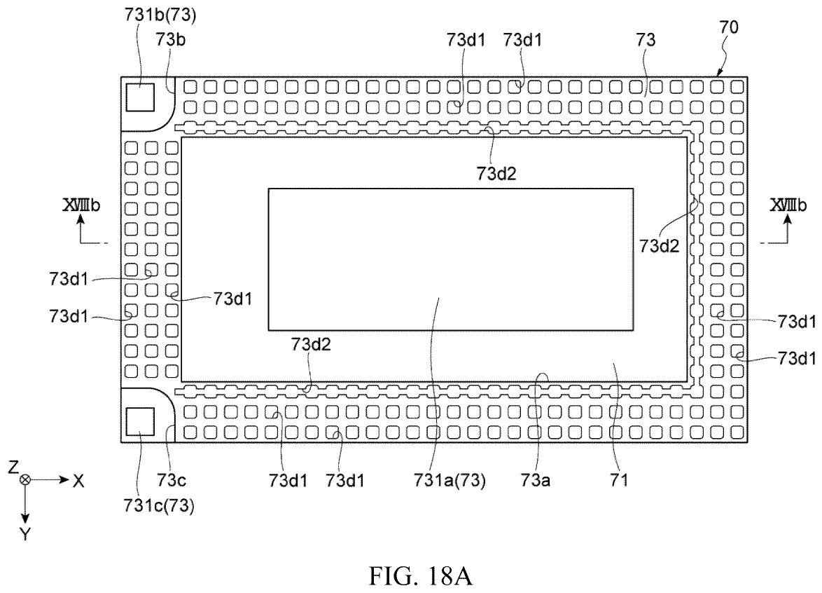

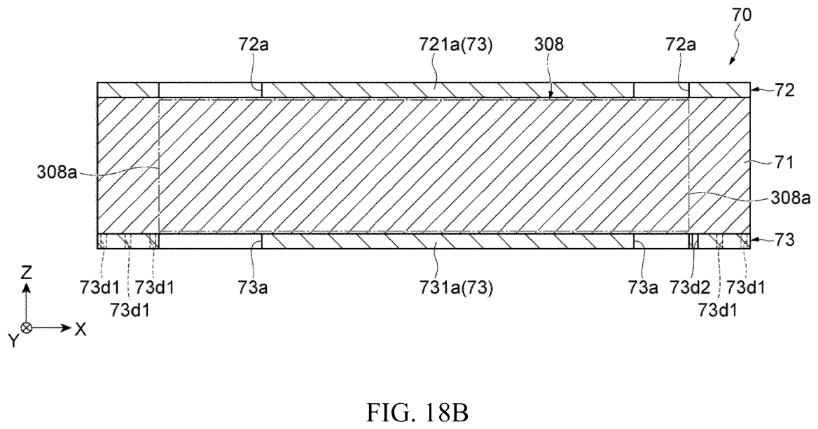

Next, as shown in FIG. 18A and FIG. 18B, by means of photolithography and etching, a through hole 73d1 to become the concave portion 306a and a through hole 73d2 to become the concave portion 306b are formed in the second oxide film 73.

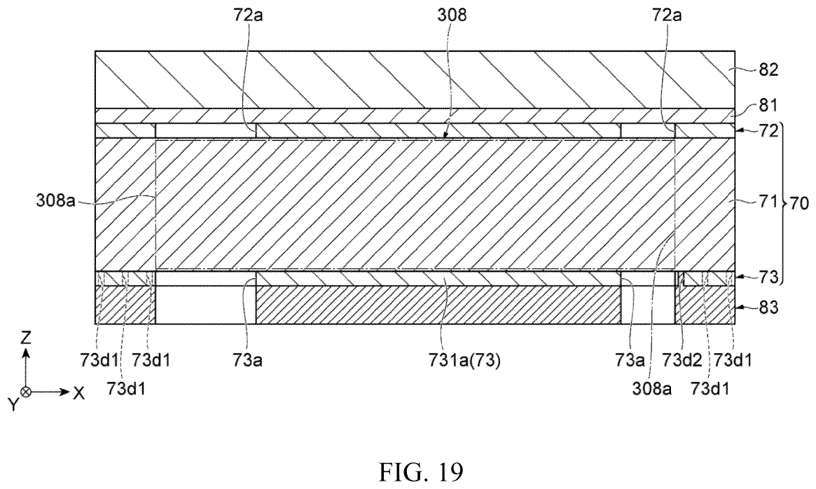

Then, as shown in FIG. 19, a support substrate 82 is adhered onto the first oxide film 72 across from a strip layer 81. A resist film 83 is formed on the second oxide film 73. At this point, a portion of the resist film 83 also fills the through hole 73d.

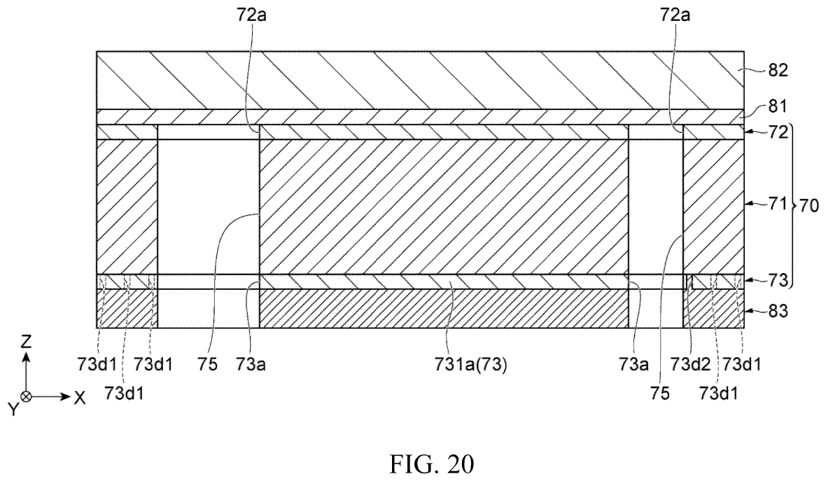

Next, as shown in FIG. 20, the silicon substrate 71 is etched by using the resist film 83 as a mask, thereby forming a through hole 75 penetrating the substrate 71 from the opening 73a to the opening 72a. Similarly, a through hole (not shown) penetrating the substrate 70 from the opening 73b to the opening 72b, and a through hole (not shown) penetrating the substrate 71 from the opening 73c to the opening 72c are formed.

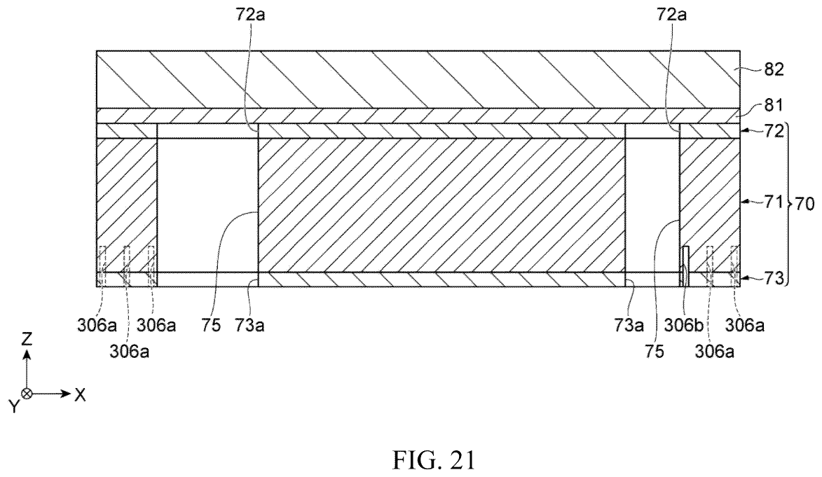

Next, as shown in FIG. 21, after the resist film 83 is removed, the silicon substrate 71 is etched by using the second oxide film 73 as a mask. Accordingly, the through hole 73d1 and the through hole 73d2 extend toward the silicon substrate 71, and form the concave portion 306a and the concave portion 306b.

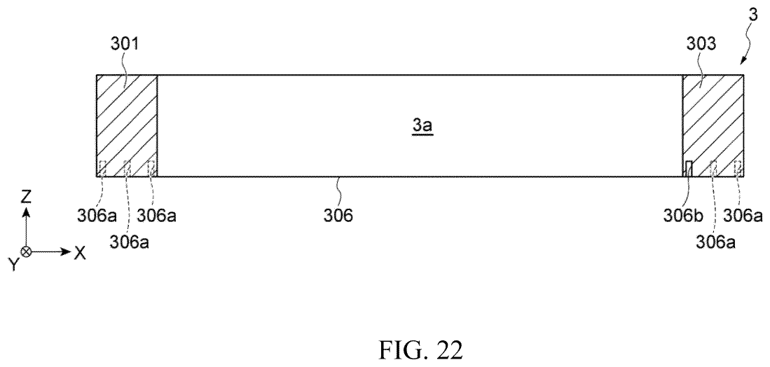

Then, the support substrate 82 and the strip layer 81 are stripped from the substrate 70. The island region 721a is separated from its surroundings by the through hole 73, and so a region in the silicon substrate 71 corresponding to the island region 721a is removed along with the support substrate 82. Accordingly, the cavity 3a is formed in the substrate 70. By stripping the support substrate 82 from the substrate 70, a region in the silicon substrate 71 corresponding to the island region 721b and the island region 721c is removed along with the support substrate 82. Accordingly, the open portion 305a and the open portion 305b are formed. Then, by removing the first oxide film 72 and the second oxide film 73, the lid 3 shown in FIG. 22 is obtained.

### <Bonding Step>

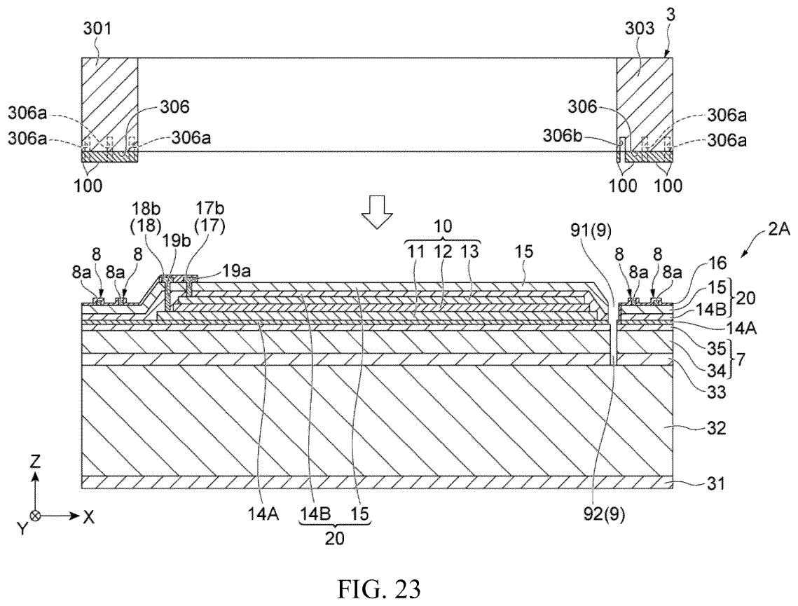

In the bonding step, as shown in FIG. 23, the adhesive 100 is applied in a region other than concave portions 306a and 306b on a surface (the bonding surface 306) where the concave portions 306a and 306b are formed in the lid 3, and the lid 3 is fixed at the substrate assembly semi-finished product 2A.

### <Mode Cavity Formation Step>

In the mode cavity formation step, the silicon substrate 32 is thinned into a film by grinding the silicon oxide film 31 and the silicon substrate 32 of the substrate assembly semi-finished product 2A. Then, a resist mask corresponding to the mode cavity formation predetermined region is formed on a lower surface of the silicon substrate 32, and the silicon substrate 32 is etched from the lower surface. Accordingly, the mode cavity 5 is formed. As a result, the sound wave generating device 1 including the support substrate 4, the oscillating device 6 and the lid 3 (referring to FIG. 1, FIG. 2, FIG. 3A, FIG. 3B, FIG. 4 and FIG. 5) is obtained.

The mode cavity formation step can also be implemented by adhering the support substrate onto the lid 3. In this case, after the mode cavity 5 is formed, the support substrate is stripped to thereby obtain the sound wave generating device 1.

The sound wave generating device 1 of the first embodiment includes the support substrate 5 having the mode cavity, the oscillating device 6 supported on the support substrate, and the lid 3 having the cavity 3a and bonded to the oscillating device 6 by the adhesive 100. The oscillating device 6 includes: the first frame 61, surrounding the mode cavity 5 when viewed from the lid 3, and having the bonding surface 61a bonded to the lid 3 by the adhesive 100; and the cantilever (the oscillating unit) 62, facing to the mode cavity 5, and having the piezoelectric element 10. The first edge 621 as a portion of the cantilever 62 is connected to the first frame 61. When viewed from a connection direction of the oscillating device 6 and the lid 3 (equivalent to the Z direction), a portion of the cantilever 62 other than the connecting portion between the cantilever 62 and the first frame 61 is separated from the first frame 61 by the slit 9 penetrating the oscillating device 6 along the connection direction. The lid 3 has the second frame 30, which surrounds the cavity 3a and includes the bonding surface 306 bonded to the bonding surface 306 by the adhesive 100. The mode cavity 5 is in communication with the cavity a by the slit 9. The convex portion 6 convexed toward the bonding surface 306 is formed on the bonding surface 61a. On the inner surface 615 of the first frame 61 facing to the slit 9, the step S1 recessed from the bonding surface 61a in a direction away from the lid 3 is formed.

As described above, in the sound wave generating device 1, the cantilever 62 disposed facing to the mode cavity 5 is connected to the first frame 61 at the first edge 621. The second edge 622, the third edge 623 and the fourth edge 624 of the cantilever 62 are separated from the first frame 61 by the slit 9. That is, in the cantilever 62, a connecting portion of the first edge 621 to the first frame 61 is a fixed end, and one end opposite to the fixed end in the X direction is a free end. The cantilever 62 has the piezoelectric element 10. Thus, in the oscillating device 6, oscillation is generated along the Z direction by applying a driving voltage to the piezoelectric element 10. The oscillation oscillates air and thus generates sound waves.

In the sound wave generating device 1, the lid 3 is boned to the substrate assembly 2 including the oscillating device 6. The cavity 3a in communication with the mode cavity 5 by the slit 9 is formed in the lid 3. With the cavity 3a formed, oscillation of the cantilever 62 is not obstructed even if the lid 3 is bonded to the substrate assembly 2. As shown in FIG. 3A, when the cavity 3a is formed to penetrate the lid 3, in a region corresponding to the cavity 3a, an opening is provided on a surface opposite (an upper surface) to the bonding surface 306 in the lid 3.

Accordingly, in the sound wave generating device 1 having the lid 3, sound generated by the oscillation of the cantilever 62 is emitted o an exterior through the opening 5a on a side of the lower surface of the mode cavity 5 and the cavity 3a.

In the sound wave generating device 1, by bonding the lid 3 to the substrate assembly 2, air leakage is prevented to thereby achieve improved sound characteristics of the sound wave generating device 1. The oscillating device 6 is protected by the lid 3. Further, with the lid 3 provided, rigidity of a chip is also increased.

The lid 3 is bonded to the substrate assembly 2 (more specifically, the oscillating device 6) by the adhesive 100. As described in the example of the manufacturing method of the sound wave generating device 1, when the lid 3 is bonded to the substrate assembly 2, the lid 3 is adhered to the oscillating device 6 while the bonding surface 306 of the lid 3 is applied with the adhesive 100. In this case, for example, as a distance between the bonding surface 306 and the bonding surface 61a decreases, an amount of the adhesive 100 overflown from the connecting portion between the bonding surface 306 and the bonding surface 61a is increased. In the sound wave generating device 1 using the cantilever 62 to generate sound, it is desired that the width of the slit 9 be minimized from the perspectives of preventing sound leakage and characteristics of a low sound domain. Thus, if the amount of overflow of the adhesive 100 toward the slit 9 is large, it is possible that the adhesive 100 interferes with the cantilever 62.

The convex portion 8 is formed on the bonding surface 61a of the oscillating device 6 of the first embodiment. The convex portion 8 functions as a spacer for specifying a distance between the bonding surface 61a and the bonding surface 306 of the lid 3, or as a stop member for keeping the bonding surface 306 away from the bonding surface 61a by a predetermined distance or more when the lid 3 is bonded to the substrate assembly 2. In this case, the distance between the bonding surface 61a and the bonding surface 306 is greater than a distance when no convex portion 8 is formed. Thus, a greater amount of the adhesive 100 can be present between the bonding surface 61a and the bonding surface 306, so that an amount of overflow of the adhesive 100 toward the slit 9 can be reduced.

Further, on the inner surface 615 (more specifically, the inner surfaces 611a, 612a, 613a and 614a) of the first frame 61 of the oscillating device 6, the step S1 recessed downward (toward the support substrate 4) from the bonding surface 61a is formed in a region facing to the slit 9. On a corner (an inner edge of the bonding surface 61a) between the step S1 and the bonding surface 61a, the adhesive 100 shown in FIG. 8 is suppressed by surface tension of the adhesive 100 from overflowing toward the slit 9. In other words, in contribution to the step S1, a stop position of the adhesive 100 toward the slit 9 can be defined. Further, even if a portion of the adhesive 100 flows into the step S1, the adhesive 100 is stopped on a side of a bottom (or a lower portion) of the step S1.

Thus, overflow of the adhesive 100 toward the slit 9 is unlikely to occur in the sound wave generating device 9 including the oscillating device 6 in which the convex portion 8 and the step S1 are formed. Thus, a gap between the first frame 61 and the cantilever 62 separated by the slit 9 can be appropriately ensured. Hence, the adhesive 100 is prevented from interfering with the cantilever 62. Since the overflow of the adhesive 100 toward the slit 9 is suppressed, the width of the slit 9 can be made narrower. As a result, sound leakage is further prevented while achieving improved characteristics of a low sound domain.

An example of the manufacturing method of the sound wave generating device 1 of the first embodiment includes: the substrate assembly semi-finished product formation step (the laminate formation step) of forming the substrate assembly semi-finished product 2A which is the laminate of the substrate 401 that is to be the support substrate 4 and the oscillating device 6; the lid formation step of forming the lid 3; the bonding step of bonding the lid 3 to the oscillating device 6; and the mode cavity formation step (the cavity formation step) of forming the mode cavity 5 in the mode cavity formation predetermined region 501 of the substrate 401. The substrate assembly semi-finished product formation step includes: forming the intermediate laminate 101 including the oscillating membrane formation layer 7, the piezoelectric element 10 and the insulative film 20, the oscillating membrane formation layer 7 laminated on the substrate 401, the piezoelectric element 10 disposed above the mode cavity formation predetermined region 501 in the oscillating membrane formation layer 7; forming the groove 911 in the intermediate laminate 101 from a side of the insulative film 20 along the outer periphery 501a of the mode cavity formation predetermined region 501, other than a portion of the outer periphery 501a of the mode cavity formation predetermined region 501; forming the convex portion 9 on the outside of the mode cavity formation predetermined region 501 in the insulative film 20; and separating the intermediate laminated 101 into the cantilever (the oscillating unit) 62 including the piezoelectric element 10, and the first frame 61 connected to a portion of the cantilever 62 and surrounding the cantilever 62 by forming the through hole 912 penetrating the intermediate laminate 101 in a portion of the bottom surface 911a of the groove 911, thereby obtaining the oscillating device 6. The lid formation step includes: forming the cavity 3a to be in communication with the mode cavity 5 through the groove 911 and the through hole 912 on the substrate 70 to become the lid 3, thereby obtaining the lid 3. In the bonding step, while the bonding surface 306 of the oscillating device 6 in the lid 3 is applied with the adhesive 100, the lid 3 is bonded a surface (the bonding surface 61a) where the convex portion 8 is formed in the oscillating device 6, thereby bonding the lid 3 to the oscillating device 6. In the mode cavity formation step, the support substrate 4 in which the mode cavity 5 is formed is obtained by forming the mode cavity 5 in the substrate 401.

In an example of the manufacturing method of the sound wave generating device 1, the sound wave generating device 1 having the functions and effects described above is obtained.

In the sound wave generating device 1 of one embodiment, the lid 3 can have the concave portion 306a, as shown in FIG. 3A, FIG. 3B, FIG. 4, FIG. 5 and FIG. 9. In this case, a portion of the adhesive 100 can enter the concave portion 306a. Thus, while the bonding surface 306 is applied with the adhesive 100, when the lid 3 is bonded to the substrate assembly 2 (more specifically, the oscillating device 6), the concave portion 306a functions as a portion for releasing a portion of the adhesive 100. As a result, the adhesive 100 is unlikely to overflow toward the slit 9. When viewed along the Z direction, in a form where the concave portion 306b near the slit 9 (or near the cavity 3a) is formed in the bonding surface 306, overflow of the adhesive 100 extruded toward the slit 9 due to approaching of the bonding surface 306 to the convex portion 8 can be better prevented.

In the sound wave generating device 1 and the manufacturing method thereof, a silicon oxide layer can be formed on an active layer containing silicon. When the sound wave generating device 1 is manufactured under the form above, the SOI substrate in which the silicon oxide film 35 is present on the silicon layer 34 with the thermal oxidation treatment performed in FIG. 10 can be used. When the silicon layer 34 of the embodiment is used as the active layer containing silicon and the silicon oxide film 35 is used as the silicon oxide layer, functions and effects when the silicon oxide layer is formed on the active layer containing silicon are described.

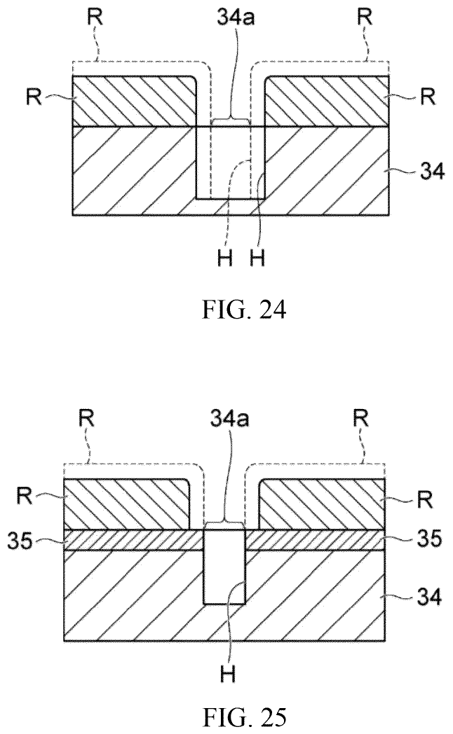

In the sound wave generating device 1 in which the silicon oxide film 35 is present on the silicon layer 34, the slit 9 penetrates the silicon oxide film 35 and the silicon layer 34 so as to be in communication with the mode cavity 5, as shown in FIG. 3A, FIG. 3B, FIG. 4 and FIG. 5. To improve sound characteristics (more particularly characteristics of a low sound domain), the width of the slit 9 can be made to be narrower. In a form where the silicon oxide film 35 is present on the silicon layer 34, the width of the slit 9 (more specifically, the lower slit portion 92) can be more easily controlled compared to when no silicon oxide film 35 is present on the silicon layer 34. Associated details of the above are described with reference to FIG. 24 and FIG. 25 below. FIG. 24 shows a diagram for illustrating a reference example of a method of forming a hole in a silicon layer. FIG. 25 shows a diagram of a method of forming a hole on a silicon layer when a silicon oxide layer is present on a silicon layer. In FIG. 24 and FIG. 25, a state after a hole H1 is formed by a method described with reference to FIG. 24 and FIG. 25 is illustrated.

First of all, as shown in FIG. 24, an example (a reference example) of a method of forming a hole H on the silicon layer 34 when no silicon oxide film 35 is present on the silicon layer 34 is described. In this case, a resist film R indicated by dotted lines is formed on the silicon layer 34 to expose a corresponding hole formation region 34a where the hole H (the hole H shown by the dotted lines in FIG. 24) is to be formed on the silicon layer 34. The silicon layer 34 is etched by using the resist film R as a mask. In this case, during the process of etching, as shown by the solid lines, a portion of the resist film R used as a mask is also removed. As a result, the hole H (the hole indicated by the solid lines) having a greater diameter than the desired hole H indicated by the dotted lines is formed.

Next, as shown in FIG. 25, an example of a method of forming the hole H in the silicon layer 34 and the silicon oxide film 35 when the silicon oxide film 35 is laminated on the silicon layer 34 is described. In FIG. 25, a hole formation region is also referred to as the hole formation region 34a.

In this case, in a laminate of the silicon layer 34 and the silicon oxide film 35, the resist film R indicated by dotted lines is formed on the silicon oxide film 35 to expose the corresponding hole formation region 34a where the hole is to be formed. The silicon oxide film 35 and the silicon layer 34 are etched contiguously by using the resist film R as a mask. In this case, during the process of etching, as shown by the solid lines, a portion of the resist film R used as a mask is also removed. However, since the silicon oxide film 35 has a higher selectivity than the resist film R, the desired hole H is formed in the silicon oxide film 35 before a portion of the resist film R is etched. As such, when the desired hole H is formed in the silicon oxide film 35, the silicon oxide film 35 functions as a mask for etching of the silicon layer 34. As a result, the hole H closer to the desired hole H is formed.

As described above, in the sound wave generating device 1, the width of the slit can be made to be narrower since the overflow of the adhesive 100 is suppressed. In the form of the sound wave generating device 1 in which the silicon oxide film 35 is laminated on the silicon layer 34, from the perspective of the details disclosed with reference to FIG. 25, the slit 9 (more specifically, the lower slit portion 92) close to a desired shape can be formed. That is, even the slit 9 having a narrower width can be formed with precision, hence achieving improved sound characteristics.

### Second Embodiment

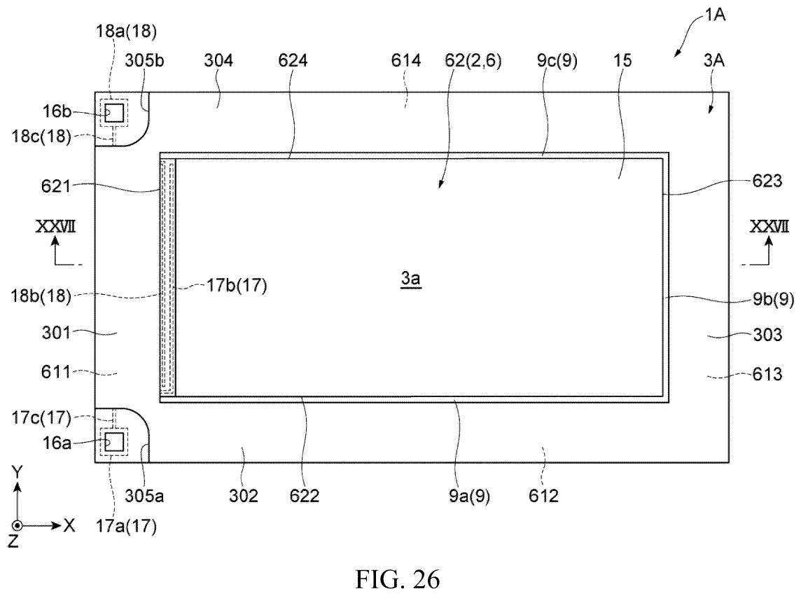

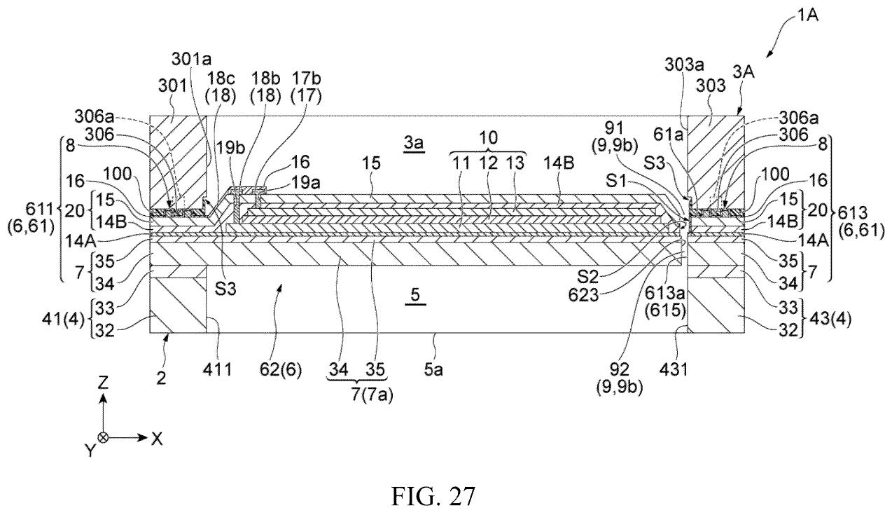

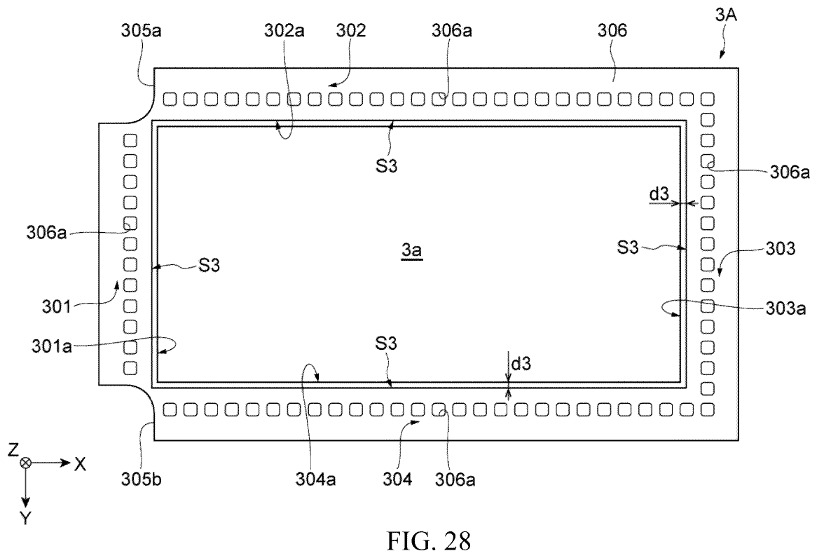

FIG. 26 shows a plan view of a sound wave generating device (a transducer) according to a second embodiment. FIG. 27 shows a cross-sectional view of the sound wave generating device in FIG. 26 along the line XXVII-XXVII. FIG. 28 shows a diagram of the lid 3A of the second embodiment viewed from a substrate assembly.

A sound wave generating device 1A of the second embodiment includes the substrate assembly 2 and a lid 3A. The sound wave generating device 1A differs from the sound wave generating device 1 of the first embodiment in that, the lid 3A is included in substitution for the lid 3. The configuration of the substrate assembly 2 of the sound wave generating device 1A of the second embodiment the same as the substrate assembly 2 described in the first embodiment. Thus, details of the substrate assembly 2 are omitted.

The lid 3A primarily differs from the lid 3 of the first embodiment in that, a step (a second step) S3 is formed on an inner surface facing to the cavity 3a. The lid 3A is described by focusing on the difference above. The lid 3A of the second embodiment is described in a form where the concave portion 306b (referring to FIG. 9) is not formed; however, the concave portion 306b can also be formed in the lid 3.

The lid 3A has the cavity 3a. The lid 3A has the first portion 301, the second portion 302, the third portion 303 and the fourth portion 304 surrounding the cavity 3a. The configuration relationship of the first portion 301, the second portion 302, the third portion 303 and the fourth portion 304 is the same as that of the first embodiment.

An inner surface 301a of the first portion 301, an inner surface 302a of the second portion 302, an inner surface 303a of the third portion 303 and an inner surface 441 of the fourth portion 304 are inner surfaces facing to the cavity 3a, and are also side surfaces of the cavity 3a. The steps S3 is formed on the inner surfaces 301a, 302a, 303a and 304a. The steps S3 formed in the inner surfaces 301a, 302a, 303a and 304a have the same configuration. Thus, as shown in FIG. 27, the step S3 is described by taking the step S3 of the inner surface 303a as an example.

As shown in FIG. 27, in the inner surface 303a, the step S3 is formed as recessed from the bonding surface 306 along a direction away from the substrate assembly 2. Thus, in the inner surface 303a, a predetermined region (a region where the step S3 is formed) is recessed from the bonding surface 306 along a direction away from (toward an outside of) the cavity 3a. An amount of recess d3 (referring to FIG. 3) can be the same as the amount of recess d1 of the inner surface 613a.

As shown in FIG. 28, multiple concave portions 306a are formed in the bonding surface 306 of the lid 3A. In FIG. 28, a situation where one column of concave portions in FIG. 9 is described; however, multiple columns of concave portions can also be formed.

An example of the manufacturing method of the sound wave generating device 1A including the lid 3A, apart from the difference in the lid formation step, is the same as the manufacturing method of the sound wave generating device 1 described in the first embodiment. Thus, the lid formation step is described and details of the other steps are omitted.

Similar to the first embodiment, the lid formation step of the second embodiment includes preparing the substrate 70 to become the lid 3 having the cavity 3a, as shown in FIG. 14B. The substrate 70 has the silicon substrate 71, the first oxide film 72 formed on the surface of the silicon substrate 71, and the second oxide film 73 formed on the back surface (the surface opposite to the surface above) of the silicon substrate 71. In the processing of the substrate 70 in the description below, aspects related to formation of the open portions 305a and 305b are the same as those of the first embodiment, and associated details are omitted as appropriate.

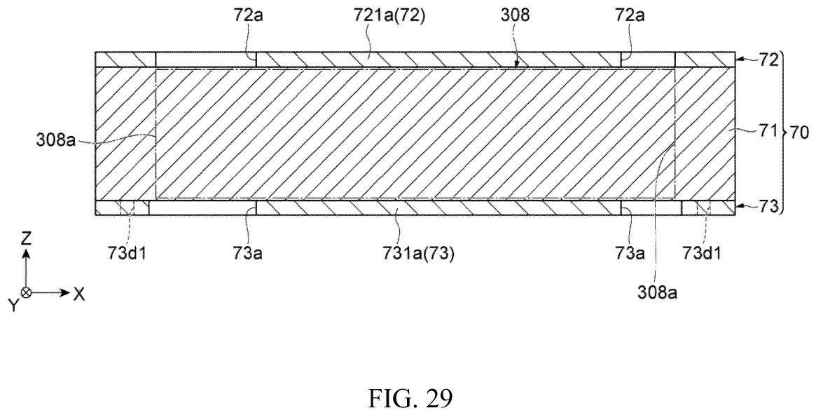

Next, as shown in FIG. 29, by means of lithography and etching, the first oxide film 72 around the island region 721a is removed to preserve the island region 721a in the first oxide film 72, thereby forming the opening 72a. By means of lithography and etching, the second oxide film 73 around the island region 731a is removed to preserve the island region 731a in the second oxide film 73, thereby forming the opening 73a. In the second embodiment, the opening 72a is formed to coincide the outer periphery of the opening 72a with an outer periphery 308a of the cavity formation predetermined region 308 in the substrate 70, and on the other hand, the opening 73a is formed to have an outer periphery of the opening 73a be located outside the outer periphery 308a. The opening 73a is formed to have the outer periphery of the opening 73a be offset from the outer periphery 308a of the cavity formation predetermined region 308 by the amount of recess d3 (to be described below) of the step S3.

Next, similar to the first embodiment, by means of photolithography and etching, a through hole 731d1 to become the concave portion 306a is formed in the second oxide film 73.

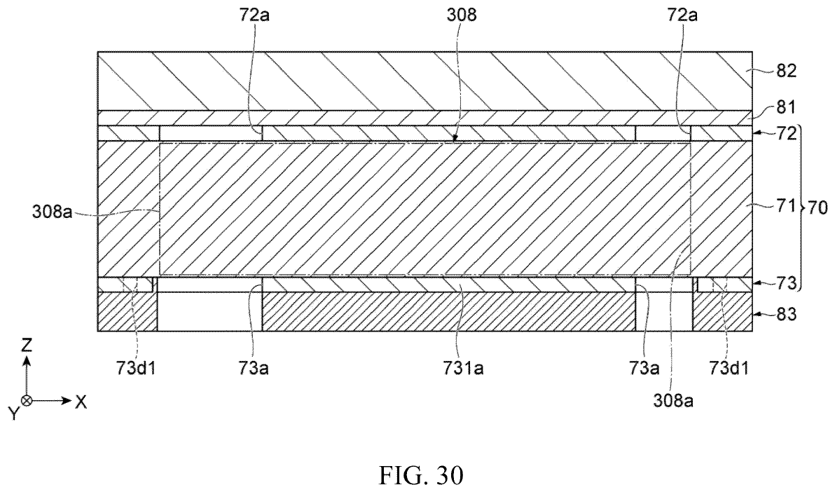

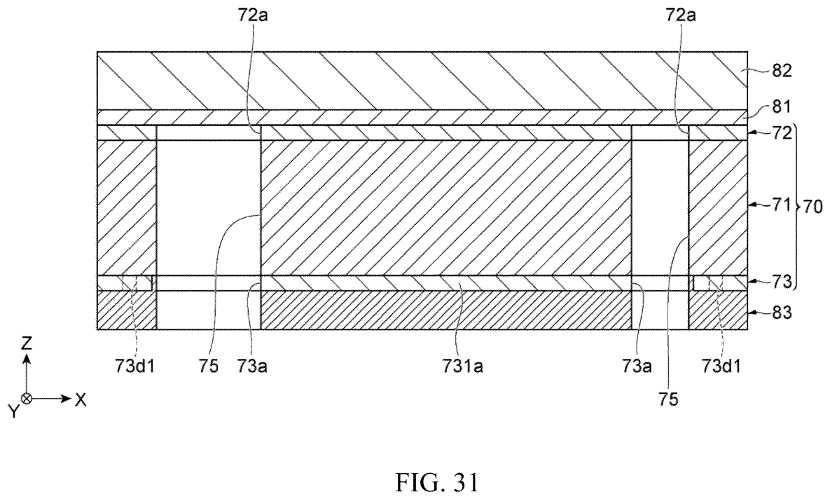

Then, as shown in FIG. 30, the support substrate 82 is adhered onto the first oxide film 72 across from the strip layer 81. A resist film 83 is formed on the second oxide film 73. At this point, a portion of the resist film 83 also fills the through hole 73d. In the second embodiment, the resist film 83 is formed to cover the outer periphery of the opening 73a. More specifically, the resist film 83 is formed to fill a gap between the outer periphery of the opening 73a and the outer periphery 308a. Next, the silicon substrate 71 is etched by using the resist film 83 as a mask, and the through hole 75 penetrating the substrate 71 from the opening 73a to the opening 72b is formed, as shown in FIG. 31.

Next, after the resist film 83 is removed, the silicon substrate 71 is etched by using the second oxide film 73 as a mask. Accordingly, the through hole 75 extends toward the silicon substrate 71, and the concave portion 306a is formed.

Next, the support substrate 82 and the strip layer 81 are stripped from the substrate 70. The island region 731a is separated from its surroundings by the through hole 73, and so a region in the silicon substrate 71 corresponding to the island region 731a is removed along with the support substrate 82. Accordingly, the cavity 3a is formed in the substrate 70. In this phase, similar to the first embodiment, the opening portion 305a and the opening portion 305b are also formed. As a result, the lid 3A shown in FIG. 26 to FIG. 28 is obtained.

The bonding step and the mode formation step described in the first embodiment are implemented by using the lid 3A obtained by the method above and the substrate assembly semi-finished product 2A described in the first embodiment. As a result, the sound wave generating device 1A including the lid 3A is obtained.

Apart from the aspect of having the step S3, the configuration of the sound wave generating device 1A is the same as that of the sound wave generating device 1, and thus the sound wave generating device 1A has the same functions and effects as those of the first sound wave generating device 1. The functions and effects of the manufacturing method of the sound wave generating device 1 are similarly the same.

In the sound wave generating device 1A, the lid 3A has the step S3. Thus, when the lid 3A applied with the adhesive 100 is bonded to the oscillating device 6, the adhesive 100 along the bonding surface 306 of the lid 3A toward the slit 9 can be released to the step S3. As a result, the adhesive 100 is suppressed from overflowing toward the slit 9.

In a form where the adhesive 100 is used to bond the oscillating device 6 having the step S1 to the lid 3A having the step S3, for both of the oscillating device 6 and the lid 3A, the adhesive 100 is even less unlikely to overflow toward the slit 9 when the overflow prevention measure for the adhesive 100 is adopted.

### Third Embodiment

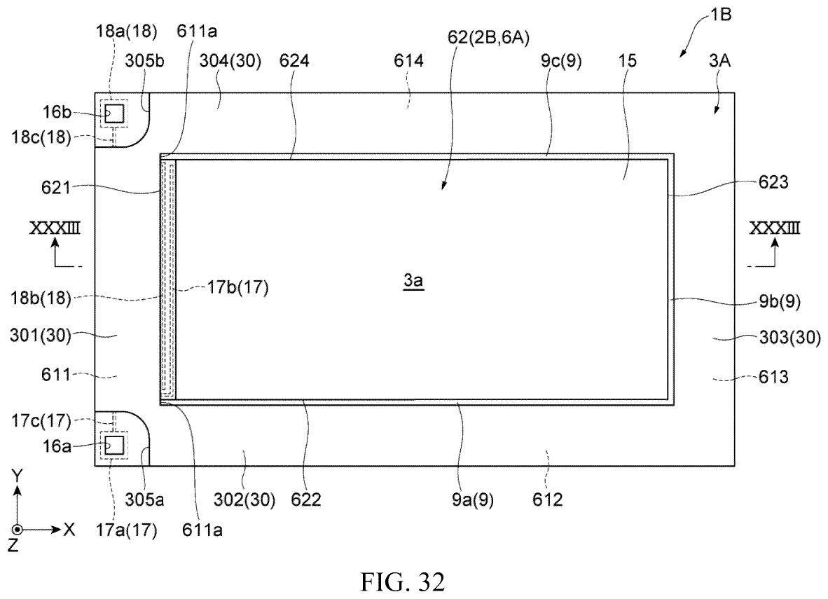

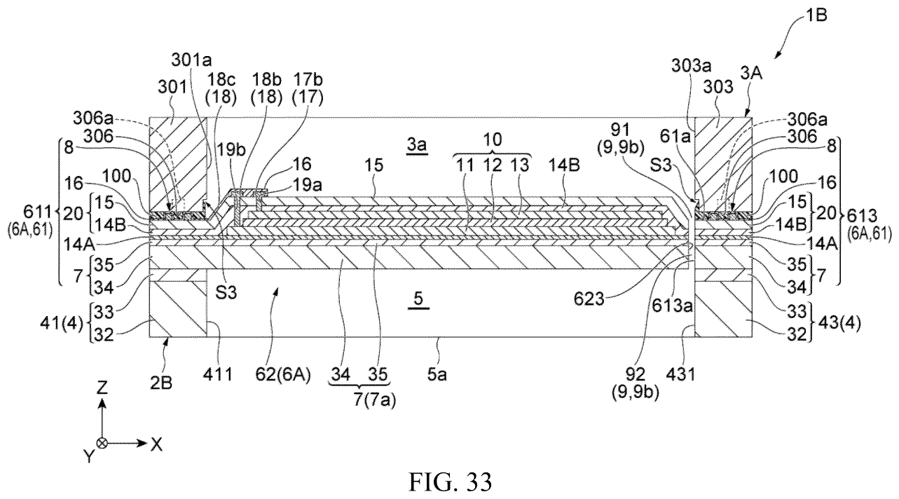

FIG. 32 shows a plan view of a sound wave generating device (a transducer) according to a third embodiment. FIG. 33 shows a cross-sectional view of the sound wave generating device in FIG. 32 along the line XXXIII-XXXIII.

A sound wave generating device 1B of the third embodiment includes a substrate assembly 2B and a lid 3A. The lid 3A is the same as the lid 3A described in the second embodiment. Thus, details of the lid 3A are omitted.

The substrate assembly 2B primarily differs from the substrate assembly 2 in excluding the steps S1 and S2. That is, the substrate assembly 2B includes the support substrate 4 having the mode cavity 5, and an oscillating device 6A. The configuration of the oscillating device 6A primarily differs from the configuration of the oscillating device 6 in that, the step S1 is not formed in the slit 9 in the inner surface (the inner surfaces 611a, 612a, 613a and 614a) of the first frame 61, and the step S2 is not formed in the second edge 622, the third edge 623 or the fourth edge 624 of the outer periphery of the cantilever 62. Apart from the above, the oscillating device 6A has the same configuration as the oscillating device 6.

Since the steps S1 and S2 are not formed, the width of the slit 9 along the extension direction (the Z direction) of the slit 9 is uniform.

The sound wave generating device 1B is manufactured by the following method, for example.

The step of forming the groove 911 described with reference to FIG. 13 in the laminate formation step described in the first embodiment is omitted. Moreover, in the step of forming the groove 911 described with reference to FIG. 14B, the through hole 912 is formed to penetrate from the passivation film 16 to the silicon oxide film 35 to obtain the slit 9, thereby manufacturing the substrate assembly semi-finish product 2A for the sound wave generating device 1B. Further, the lid 3A is formed similar that that in the second embodiment. As such, the bonding step and the mode cavity formation step described in the first embodiment are implemented on the substrate assembly semi-finish product 2A and the lid 3A formed above, thereby manufacturing a sound wave generating device 1C.

In the sound wave generating device 1B, the oscillating device 6A has the convex portion 8, and so the adhesive 100 is unlikely to overflow toward the slit 9, as described in the first embodiment. Further, the lid 3A of the sound wave generating device 1C has the step S3. Thus, the adhesive 100 is suppressed by the step S3 from overflowing toward the slit 9, as described in the second embodiment. Therefore, overflow of the adhesive 100 toward the slit 9 is unlikely to occur in the sound wave generating device 1B including the oscillating device 6 having the convex portion 8 and the lid 3A having the step S3. Hence, the adhesive 100 is prevented from interfering with the cantilever 62. Since the overflow of the adhesive toward the slit 9 is suppressed, the width of the slit 9 can be made narrower. As a result, sound leakage is further prevented while achieving improved characteristics of a low sound domain.

In the sound wave generating device 1B, a lid 3A can have the concave portion 306a formed therein. The functions and effects with the concave portion 306a formed are the same as those of the first embodiment.

### Fourth Embodiment

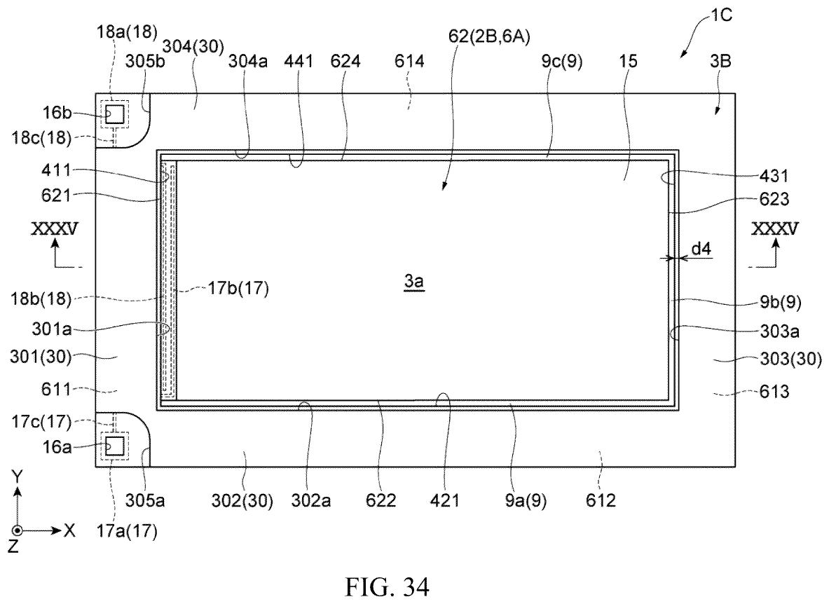

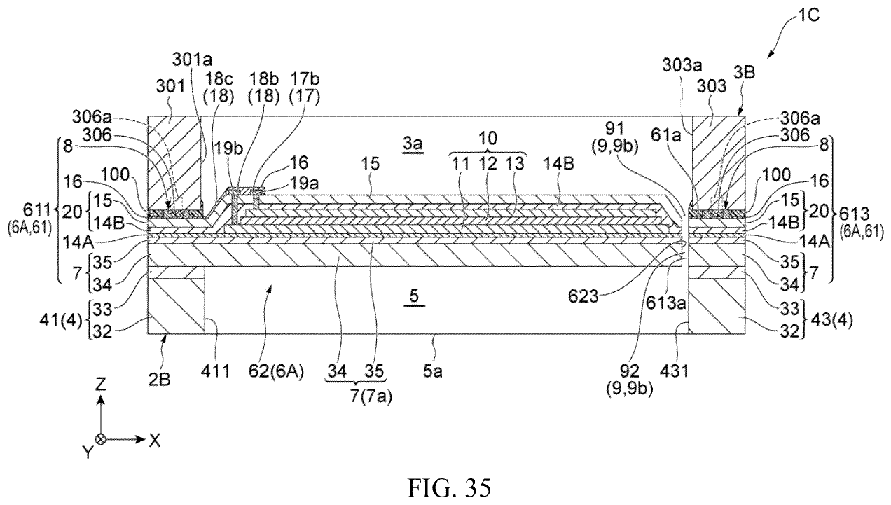

FIG. 34 shows a plan view of a sound wave generating device (a transducer) according to a fourth embodiment. FIG. 35 shows a cross-sectional view of the sound wave generating device in FIG. 34 along the line XXXV-XXXV.

A sound wave generating device 1C of the fourth embodiment includes the substrate assembly 2B and the lid 3B. The substrate assembly 2B is the same as the substrate assembly 2B described in the third embodiment. Thus, details of the substrate assembly 2B are omitted.

The lid 3B differs from the lid 3A of the second embodiment (or the third embodiment) in that, a size of the cavity 3a is greater than that of the mode cavity 5 when viewed along the Z direction. The lid 3B is described by focusing on the difference above.

The lid 3B has the first portion 301, the second portion 302, the third portion 303 and the fourth portion 304 surrounding the cavity 3a. The configuration relationship of the first portion 301, the second portion 302, the third portion 303 and the fourth portion 304 is the same as that of the first embodiment.

The inner surface 301a of the first portion 301, the inner surface 302a of the second portion 302, the inner surface 303a of the third portion 303 and the inner surface 441 of the fourth portion 304 are inner surfaces facing to the cavity 3a, and are also side surfaces of the cavity 3a.

As described above, when viewed along the Z direction, the size of the cavity 3a is greater than that of the mode cavity 5. Details of the above are described from the perspective of the configuration relationship between the inner surfaces 301a, 302a, 303a and 304a (equivalent to the side surfaces of the cavity 3a) and the inner surfaces 411, 421, 431 and 441 equivalent to the side surfaces of the mode cavity 5. The description on the configuration relationship is based on a state of when viewed along the Z direction.

The inner surface 301a is recessed outward relative to the inner surface 411. The inner surface 301b is recessed outward relative to the inner surface 421. The inner surface 301c is recessed outward relative to the inner surface 431. The inner surface 301d is recessed outward relative to the inner surface 441. In one example, the amount of recess d4 of the inner surfaces 301a, 301b, 301c and 301d relative to the inner surfaces 411, 421, 431 and 441 is between about 1 μm and about 10 μm. The amount of recess of the inner surfaces 301a, 301b, 301c and 301d relative to the inner surfaces 411, 421, 431 and 441 can be the same or can be different.

The lid 3B is formed by the method below; that is, in the lid formation step of the second embodiment, the cavity formation predetermined region is formed to be greater than the mode cavity formation predetermined region 501. The bonding step and the mode formation step described in the first embodiment are implemented by using the lid 3B obtained by the method above and the substrate assembly semi-finished product 2A described in the third embodiment, thereby manufacturing the sound wave generating device 1C.

In the sound wave generating device 1C, an oscillating device 6C has the convex portion 8, and so the adhesive 100 is unlikely to overflow toward the slit 9, as described in the first embodiment. Further, the cavity 3a the lid 3A of the sound wave generating device 1C is greater than the mode cavity 5. In this case, as shown in FIG. 35, even if the adhesive 100 toward the cavity 3a is released along the inner surface 303a in a direction away from the bonding surface 306, considering a thickness of the adhesive 100 attached on the inner surface 303a, the size of the cavity 3a can approximate the size of the mode cavity 5. Hence, the adhesive 100 attached on the inner surface 303a can be prevented from interfering with the cantilever 62. Moreover, although the adhesive 100 attached on the inner surface 303a is described as an example, the same applies to the inner surfaces 301a, 302a and 303a. As a result, sound leakage is further prevented, and at least characteristics of a low sound domain can be maintained.

The embodiments and the variation examples of the present disclosure are described as above; however, the present disclosure is not limited to these non-limiting embodiments. The present disclosure is represented by way of the claims, and is intended to cover all equivalent meanings and variations made within the scope accorded with the claims.

### First Variation Example

For example, in the embodiments, the sound wave generating device 1 includes one oscillating device 6 is described; however, the configuration of the sound wave generating device is not limited to the example above. The sound wave generating device can also include multiple (for example, a pair of) oscillating devices.

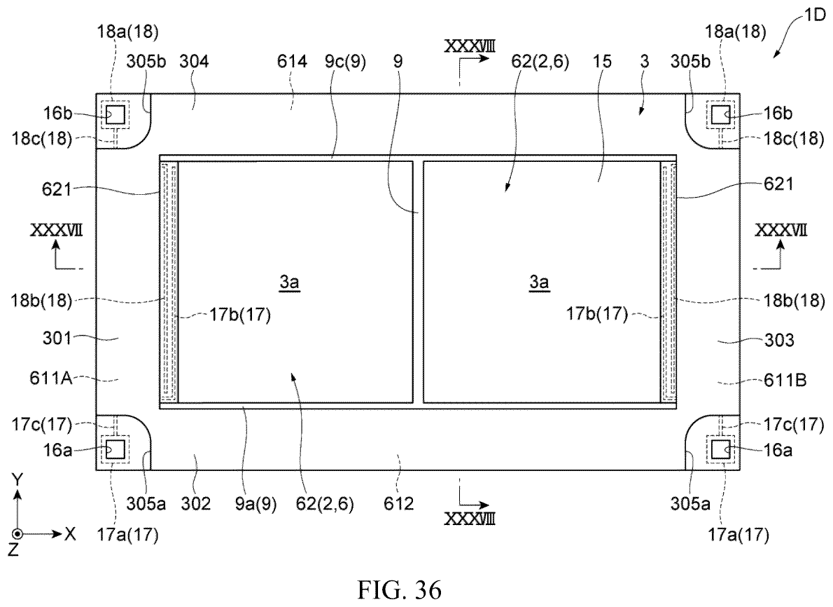

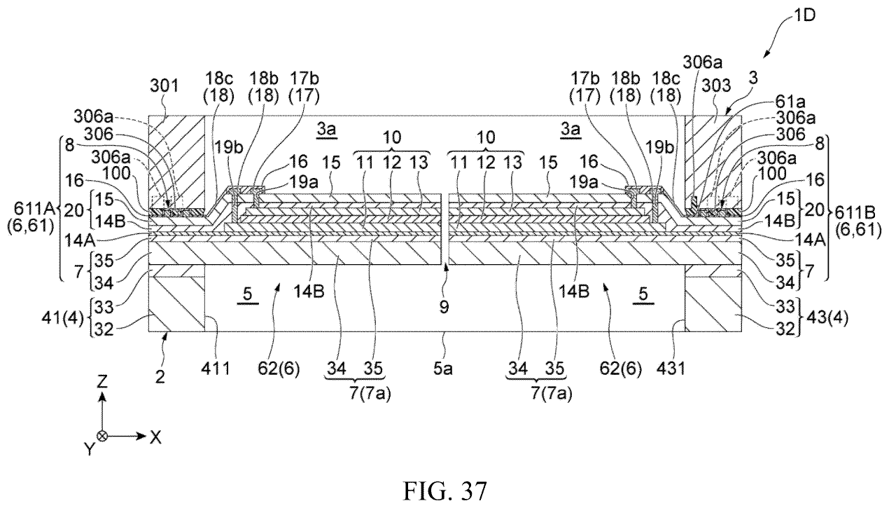

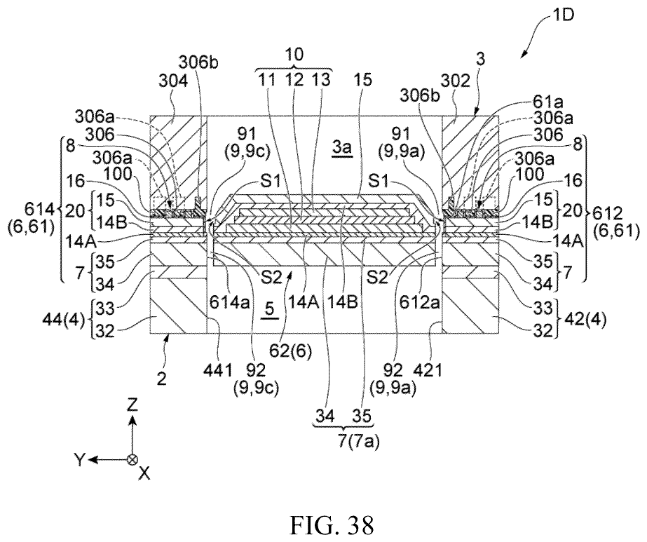

FIG. 36 shows a plan view of a sound wave generating device 1D according to a first variation example. FIG. 37 shows a cross-sectional view of the sound wave generating device 1D in FIG. 36 along the line XXXVII-XXXVII. FIG. 38 shows a cross-sectional view of the sound wave generating device 1D in FIG. 36 along the line XXXIII-XXXIII.

As shown in FIG. 36 to FIG. 38, the sound wave generating device 1D includes two (a pair of) oscillating devices 6 and 6. Similar to the oscillating device 6 connected to the first portion 611 of the first embodiment, the sound wave generating device 1D has a corresponding form where the oscillating device 6 is connected to the third portion 613 of the first frame 61 of the first embodiment. In FIG. 36 and FIG. 37, portions corresponding to the first portion 611 and the third portion 613 of the first embodiment are referred to as a 1A portion 611A and a 1B portion 611B. Free ends of the pair of oscillating devices 6 and 6 are disposed to be facing to each other. A gap between the free ends of the pair of oscillating devices 6 and 6 can be considered a portion of the slit 9.

The sound wave generating device 1D, apart from the aspect above, is the same as the sound wave generating device 1 of the first embodiment, and more particularly, the configurations of the second portions 612 and the fourth portion 614 are the same as those of the first embodiment. Accordingly, the sound wave generating device 1D provides the same functions and effects as those of the first embodiment 1D.

### Second Variation Example

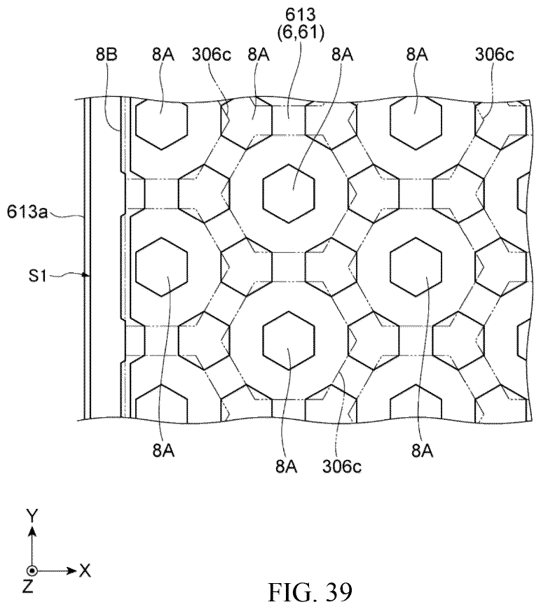

As a convex portion 8A shown in FIG. 39, a shape of the convex portion formed on the bonding surface 61a can also have a hexagonal shape. FIG. 39 is a diagram illustrating a second variation example, and is a drawing where a portion of the third portion 613 is enlarged. Among the multiple convex portions 8A, multiple columns of convex portions along the extension direction of the third portion 613 can be arranged side by side along a direction perpendicular to the extension direction of the third portion 613. As shown in FIG. 39, one column of convex portions among two columns of convex portions adjacent along a direction perpendicular to the extension direction of the third portion 613 can also be offset relative to another column of convex portions along the extension direction of the third portion 613. The columns of convex portions are formed by multiple convex portions 8A discretely arranged along the extension direction of the third portion 613.

In FIG. 39, a variation example of the concave portion formed in the bonding surface 306 of the lid 3 is also shown. Concave portions 306c shown as an example in FIG. 39 are formed in the bonding surface 306 of the lid 3 as described above; however, to illustrate the configuration relationship thereof with respect to the convex portions 8A, the concave portions 306c are represented by double-dotted lines in FIG. 39. As shown in FIG. 39, a shape of the concave portions 306c in the plan view can also have a hexagonal shape. When viewed along the Z direction, the multiple concave portions 306c can be formed to be adjacent to the convex portions 8A; however, a portion of the multiple concave portions 306a can also be formed to cover the convex portions 8A.

Convex portions 8B extending along the extension direction of the third portion 613 can also be formed near the inner surface 613a of the third portion 613. When viewed along the Z direction, a portion of the concave portions 306c overlapping with the convex portions 8B can also have a hexagonal shape from which a portion is cut out.

The variation example of the convex portions formed on the third portion 613 and the concave portions formed in the third portion of the lid 3 is described with reference to FIG. 39; however, the variation of the same convex portions can also be applied to the convex portions formed on the first portion 611, the second portion 612 and the fourth portion 614, and the variation of the concave portions can also be applied to the concave portions formed in the first portion 301, the second portion 302 and the fourth portion 304 of the lid 3.

Variations other than the first variation example and the second variation example can also be implemented. For example, the lid is not necessarily formed to have concave portions for releasing an adhesive.

For example, applications of a transducer are not limited to sound wave generating devices (speakers or ultrasound wave generating devices), and can be various other transducers, MEMS mirror or inkjet heads.

One or more elements of any one of the embodiments described above can be combined with one or more elements of another embodiment.

As described above, according to the transducer and the manufacturing method of the transducer, a gap between an oscillating unit of a piezoelectric element included therein and its surroundings can be appropriately ensured. The various embodiments of the present disclosure can be defined as the note below.

(Note 1, first and second embodiment, FIGS. 3A, 3B, 8 and 27)

A transducer, comprising:
a support substrate 4, having a first cavity 5;
an oscillating device 6, supported by the support substrate 4; and
a lid 3, having a second cavity 3a and bonded to the oscillating device 6 by an adhesive 100,
wherein the oscillating device 6 includes:
   a first frame 61, surrounding the first cavity 5 when viewed from the lid 3, and including a first bonding surface 61a bonded to the lid 3 by the adhesive 100; and
   an oscillating unit 62, facing to the first cavity 5 and including a piezoelectric element 10, wherein
a portion of the oscillating unit 62 is connected to the first frame 61,
when viewed from a connection direction of the oscillating device 6 and the lid 3, the portion of the oscillating unit 62 other than a connecting portion between the oscillating unit 62 and the first frame 61 is separated from the first frame 61 by a slit 9 penetrating the oscillating device 6 along the connection direction,
the lid 3 has a second frame 30 surrounding the second cavity 3a and including a second bonding surface 306 bonded to the first bonding surface 61a by the adhesive 100,
the first cavity 5 and the second cavity 3a are connected by the slit 9,
the first bonding surface 61a has a convex portion 8 convexed toward the second bonding surface 306, and
an inner surface 615 of the first frame 61 facing to the slit 9 has a first step S1 recessed from the first bonding surface 61a and facing away from the lid 3.
   (Note 2, second embodiment, FIGS. 27 and 28)

The transducer of Note 1, wherein a second step S3 recessed along a direction away from the oscillating device 6 is formed on an inner surface 301a, 302a, 303a or 304a of the second bonding surface 306 facing to the second cavity 3a.

(Note 3, first to third embodiments, FIGS. 3A, 3B, 27 and 35)

The transducer of Note 1 or 2, wherein a plurality of recesses 306a are formed on the second bonding surface 306.

(Note 4, first to third embodiments, FIGS. 3A, 3B, 27 and 35)

The transducer of any one of Notes 1 to 3, wherein the oscillating device 6 includes: an active layer 32, laminated on the support substrate 4 and including silicon; and a silicon oxide layer 33, laminated on an opposite side of the support substrate 4 to the active layer 32.

(Note 5, third embodiment, FIGS. 32 and 33)

A transducer, comprising:
a support substrate 4, having a first cavity 5;
an oscillating device 6A, supported by the support substrate 4; and
a lid 3A, having a second cavity 3a and bonded to the oscillating device 6A by an adhesive 100, wherein the oscillating device 6A includes:
   a first frame 61, surrounding the first cavity 5 when viewed from the lid 3A, and including a first bonding surface 61a bonded to the lid 3A by the adhesive 100; and
   an oscillating unit 62, facing to the first cavity 5 and including a piezoelectric element 10, wherein
a portion of the oscillating unit 62 is connected to the first frame 61,
when viewed from a connection direction of the oscillating device 6A and the lid 3A, the portion of the oscillating unit 62 other than a connecting portion between the oscillating unit 62 and the first frame 61 is separated from the first frame 61 by a slit 9 penetrating the oscillating device 6A along the connection direction,
the lid 3A has a second frame 30 surrounding the second cavity 3a and including a second bonding surface 306 bonded to the first bonding surface 61a by the adhesive 100,
the first cavity 5 and the second cavity 3a are connected by the slit 9,
the first bonding surface 61a has a convex portion 8 convexed toward the second bonding surface 306, and
a step S3 recessed toward a side opposite to the oscillating device 6A is formed on an inner surface 301a, 302a, 303a or 304a of the second bonding surface 306 facing to the second cavity 3a.
   (Note 6, fourth embodiment, FIGS. 34 and 35)

A transducer, comprising:
a support substrate 4, having a first cavity 5;
an oscillating device 6A, supported by the support substrate 4; and
a lid 3B, having a second cavity 3a and bonded to the oscillating device 6A by an adhesive 100, wherein the oscillating device 6A includes:
   a first frame 61, surrounding the first cavity 5 when viewed from the lid 3B and including a first bonding surface 61a bonded to the lid 3B by the adhesive 100; and
   an oscillating unit 62, facing the first cavity 5 and including a piezoelectric element 10, wherein
a portion of the oscillating unit 62 is connected to the first frame 61,
when viewed from a connection direction of the oscillating device 6A and the lid 3B, the portion of the oscillating unit 62 other than a connecting portion between the oscillating unit 62 and the first frame 61 is separated from the first frame 61 by a slit 9 penetrating the oscillating device 6A along the connection direction,
the lid 3B has a second frame 30 surrounding the second cavity 3a and including a second bonding surface 306 bonded to the first bonding surface 61a by the adhesive 100,
the first cavity 5 and the second cavity 3a are connected by the slit 9,
the first bonding surface 61a has a convex portion 8 convexed toward the second bonding surface 306, and
a size of the second cavity 3a is substantially greater than a size of the first cavity 5 when viewed along the connection direction.
   (Note 7, first embodiment, FIGS. 10 to 23)

A method of manufacturing a transducer including a support substrate 4 having a first cavity 5, an oscillating device 6 stacked on the support substrate 4, and a lid 3 having a second cavity 3a and bonded to the oscillating device 6 by an adhesive 100, the method comprising:
forming a laminate 2A of:
   a first substrate 401 to be the support substrate 4; and
   the oscillating device 6;
forming the lid 3;
bonding the lid 3 to the oscillating device 6; and

forming a first cavity 5 in a region 501 of the first substrate 401 where the first cavity 5 is to be formed, wherein
the forming of the laminate 2A includes:
   forming an intermediate laminate 101 having:
      an oscillating membrane formation layer 7, laminated on the first substrate 401;
      a piezoelectric element 10, disposed in the oscillating membrane formation layer 7 and above the region 501 where the first cavity 5 is to be formed; and
      an insulative film 20, covering the piezoelectric element 10 and the oscillating membrane formation layer 7,
   forming a groove 911 in the intermediate laminate 101 from a side of the insulative film 20 along an outer periphery 501a of the region 501 where the first cavity 5 is to be formed, other than a portion of the outer periphery 501a of the region 501 where the first cavity 5 is to be formed;
   forming a convex portion 8 in the insulative film 20 outside the region 501 where the first cavity 5 is to be formed; and
   obtaining the oscillating device 6,
      by forming a through hole 912 penetrating the intermediate laminate 101 in a portion of a bottom surface 911a of the groove 911, and
      by separating the intermediate laminate 101 into an oscillating unit 62 including the piezoelectric element 10 and a frame 61 partially connected to and surrounding the oscillating unit 62, wherein
in the forming of the lid 3, a second cavity 3a communicable with the first cavity 5 via the groove 911 and the through hole 912 is formed in a second substrate 70 that is to be the lid 3, thereby forming the lid 3;
in the bonding of the lid 3, an adhesive 100 is applied to a bonding surface 306 of the lid 3 with respect to the oscillating device 6, and the lid 3 is bonded to a surface of the oscillating device 6 on which the convex portion 8 is formed, thereby bonding the lid 3 to the oscillating device 6; and
in the forming of the first cavity 5, the first cavity 5 is formed in the first substrate 401 to obtain a support substrate 4 in which the first cavity 5 is formed.
   (Note 8, first embodiment, FIG. 10)

The method of Note 7, wherein the oscillating membrane formation layer 7 includes:
an active layer 32, laminated on the support substrate 4 and including silicon; and
a silicon oxide layer 33, laminated on an opposite side of the support substrate 4 to the active layer 32.

1. A transducer, comprising:
a support substrate, having a first cavity;
an oscillating device, supported by the support substrate; and
a lid, having a second cavity and bonded to the oscillating device by an adhesive, wherein the oscillating device includes:
a first frame, surrounding the first cavity when viewed from the lid, and including a first bonding surface bonded to the lid by the adhesive; and
an oscillating unit, facing to the first cavity and including a piezoelectric element, wherein
a portion of the oscillating unit is connected to the first frame,
when viewed from a connection direction of the oscillating device and the lid, the portion of the oscillating unit other than a connecting portion between the oscillating unit and the first frame is separated from the first frame by a slit penetrating the oscillating device along the connection direction,
the lid has a second frame surrounding the second cavity and including a second bonding surface bonded to the first bonding surface by the adhesive,
the first cavity and the second cavity are connected by the slit,
the first bonding surface has a convex portion convexed toward the second bonding surface, and
an inner surface of the first frame facing to the slit has a first step recessed from the first bonding surface and facing away from the lid.

2. The transducer of claim 1, wherein a second step recessed along a direction away from the oscillating device is formed on an inner surface of the second bonding surface facing to the second cavity.

3. The transducer of claim 1, wherein a plurality of recesses are formed on the second bonding surface.

4. The transducer of any one of claim 1, wherein the oscillating device includes:
an active layer, laminated on the support substrate and including silicon; and
a silicon oxide layer, laminated on an opposite side of the support substrate to the active layer.

5. The transducer of any one of claim 2, wherein the oscillating device includes:
an active layer, laminated on the support substrate and including silicon; and
a silicon oxide layer, laminated on an opposite side of the support substrate to the active layer.

6. The transducer of any one of claim 3, wherein the oscillating device includes:
an active layer, laminated on the support substrate and including silicon; and
a silicon oxide layer, laminated on an opposite side of the support substrate to the active layer.

7. A transducer, comprising:
a support substrate, having a first cavity;
an oscillating device, supported by the support substrate; and
a lid, having a second cavity and bonded to the oscillating device by an adhesive, wherein the oscillating device includes:
a first frame, surrounding the first cavity when viewed from the lid, and including a first bonding surface bonded to the lid by the adhesive; and
an oscillating unit, facing to the first cavity and including a piezoelectric element, wherein
a portion of the oscillating unit is connected to the first frame,
when viewed from a connection direction of the oscillating device and the lid, the portion of the oscillating unit other than a connecting portion between the oscillating unit and the first frame is separated from the first frame by a slit penetrating the oscillating device along the connection direction,
the lid has a second frame surrounding the second cavity and including a second bonding surface bonded to the first bonding surface by the adhesive,
the first cavity and the second cavity are connected by the slit,
the first bonding surface has a convex portion convexed toward the second bonding surface, and
a step recessed toward a side opposite to the oscillating device is formed on an inner surface of the second bonding surface facing to the second cavity.

8. A transducer, comprising:
a support substrate, having a first cavity;
an oscillating device, supported by the support substrate; and
a lid, having a second cavity and bonded to the oscillating device by an adhesive, wherein the oscillating device includes:
a first frame, surrounding the first cavity when viewed from the lid and including a first bonding surface bonded to the lid by the adhesive; and
an oscillating unit, facing the first cavity and including a piezoelectric element, wherein
a portion of the oscillating unit is connected to the first frame,
when viewed from a connection direction of the oscillating device and the lid, the portion of the oscillating unit other than a connecting portion between the oscillating unit and the first frame is separated from the first frame by a slit penetrating the oscillating device along the connection direction,
the lid has a second frame surrounding the second cavity and including a second bonding surface bonded to the first bonding surface by the adhesive,
the first cavity and the second cavity are connected by the slit,
the first bonding surface has a convex portion convexed toward the second bonding surface, and
a size of the second cavity is substantially greater than a size of the first cavity when viewed along the connection direction.

9. A method of manufacturing a transducer including a support substrate having a first cavity, an oscillating device stacked on the support substrate, and a lid having a second cavity and bonded to the oscillating device by an adhesive, the method comprising:
forming a laminate of:
a first substrate to be the support substrate; and
the oscillating device;
forming the lid;
bonding the lid to the oscillating device; and
forming a first cavity in a region of the first substrate where the first cavity is to be formed, wherein
the forming of the laminate includes:
forming an intermediate laminate having:
an oscillating membrane formation layer, laminated on the first substrate;
a piezoelectric element, disposed in the oscillating membrane formation layer and above the region where the first cavity is to be formed; and
an insulative film, covering the piezoelectric element and the oscillating membrane formation layer,
forming a groove in the intermediate laminate from a side of the insulative film along an outer periphery of the region where the first cavity is to be formed, other than a portion of the outer periphery of the region where the first cavity is to be formed;
forming a convex portion in the insulative film outside the region where the first cavity is to be formed; and
obtaining the oscillating device,
by forming a through hole penetrating the intermediate laminate in a portion of a bottom surface of the groove, and
by separating the intermediate laminate into an oscillating unit including the piezoelectric element and a frame partially connected to and surrounding the oscillating unit, wherein
in the forming of the lid, a second cavity communicable with the first cavity via the groove and the through hole is formed in a second substrate that is to be the lid, thereby forming the lid;
in the bonding of the lid, an adhesive is applied to a bonding surface of the lid with respect to the oscillating device, and the lid is bonded to a surface of the oscillating device on which the convex portion is formed, thereby bonding the lid to the oscillating device; and
in the forming of the first cavity, the first cavity is formed in the first substrate to obtain a support substrate in which the first cavity is formed.

10. The method of claim 9, wherein the oscillating membrane formation layer includes:
an active layer, laminated on the support substrate and including silicon; and
a silicon oxide layer, laminated on an opposite side of the support substrate to the active layer.
